(19) United States
(12) Patent Application Publication
(10) Pub. No.: US 2005/0205778 A1
(43) Pub. Date: Sep. 22, 2005

(54) Laser trim motion, calibration, imaging, and fixturing techniques

(75) Inventors: Anton T. Kitai, Ottawa (CA); Andreas Mank, Ottawa (CA); Paul A. Labelle, Smith Falls (CA); Andrei Naumov, Ottawa (CA); Ian J. Miller, Ottawa (CA); Robert G. Parker, Ottawa (CA)

Correspondence Address: MAINE & ASMUS, 100 MAIN STREET, P O BOX 3445, NASHUA, NH, 03061-3445, US

(73) Assignee: GSI LUMONICS CORPORATION, Billerica, MA (US)

(21) Appl. No.: 10/967,432

(22) Filed: Oct. 18, 2004

Related U.S. Application Data
(60) Provisional application No. 60/512,048, filed on Oct. 17, 2003.

(51) Int. Cl. G21K 7/00

(52) U.S. Cl. 250/309; 250/310

(57) ABSTRACT

A system for probing circuit elements, includes a panel fixture, probe holder and stage. The fixture has a platen surface to support a work piece having work piece surface. The work piece surface is substantially parallel to the platen surface and has a target element thereon. The probe holder is configured to support a probe for detecting a characteristic of the target element. A stage rotates the probe holder about an axis substantially orthogonal to the platen surface, to align the probe with probe locations associated with the circuit element, so that the characteristic of the circuit element can detected by the probe. Fixturing motion can be optimized for efficient work piece manufacturing. Calibration and vision subassemblies are also provided.

### RELATED APPLICATIONS

This application claims the benefit of U.S. Provisional Application No. 60/512,048, filed Oct. 17, 2003, which is herein incorporated in its entirety by reference.

### FIELD OF THE INVENTION

The invention relates to energy beam scanning, and more particularly, to laser trim motion, calibration, imaging, and fixturing techniques.

### BACKGROUND OF THE INVENTION

It is known to change the electrical properties of passive and some active electronic elements by removing material therefrom. Methods of removing material include applying laser energy for vaporizing a portion of the material, applying laser energy for ablative removal of the material, and applying laser energy to affect a photochemical reaction for removing and/or otherwise altering an electrical performance characteristic of the material. The relative effect of these three processes depends on the energy density and wavelength of the laser, and the properties of the material illuminated by the laser.

Laser material processing is routinely performed using a position and power controlled laser beam that is directed to scan over a desired region of the material for processing. These techniques are used to process individual passive electronic elements such as resistors, capacitors and inductors, as well as to process electrical elements in microchips (e.g., for memory chip repair and/or for trimming electrical elements formed onto silicon or other crystalline substrates). A conventional beam-directing device of a laser material processing system usually includes a galvanometer and scan lens, which is used to position the laser beam.

In particular, a laser beam is directed over a region of the electrical element to remove or trim material from the element. The trimming may affect the electrical performance of the element by reducing the volume of electrical material in the element or by altering a path of electron flow through the material, e.g. by creating a longer resistive path or even by creating an open circuit by completely removing a conductive path between two elements. It is well known in the manufacturing of precision electrical resistors to laser trim each resistor to adjust its resistive value to fall within a desired range. It is also known to measure the resistive value during the laser trimming process and to continue to trim the resistor until the resistive value is acceptable.

In laser subsystems, the beam-directing device must be calibrated. More particularly, the galvanometer mirror scanners, which are often referred to as a “galvo” or “galvos”, or other type scanner componentry must be calibrated to eliminate field distortions inherent in the scan lens typically included in such subsystems. Such distortions will otherwise result in a pin cushion-type of field pattern. To accomplish the calibration correction, the distortion has to be translated into a regular X-Y grid pattern with the correct size, shape, and orthogonality for the accuracy that is required for full trimming. As shown in FIG. 1 the objective is to go from the non-ideal distortion situation as shown in A to the regular grid as shown in B.

Referring to FIG. 2a, a first option for calibrating the beam-directing device is to place a sacrificial plate 210 in the trimming system at the work piece location. Typically, the sacrificial plate is placed on a substrate fixture 200. The sacrificial plate 210 has marks 220 that are made using a laser beam scanned across the scan field of the beam-directing device and scan lens. Ideally, marks 220 would be a regular array of points in a grid pattern. However, the marks 220 are typically in a distorted pattern naturally because of the distortions and non-linearity inherent to the system.

FIG. 2b shows a top view of marks 220 through a camera vision subsystem looking through the scan lens of the beam-directing device. In a first calibration option, the locations of marks 220 at the center of a cross hair for each of the marks is found. Offsets from ideal locations of those marks are determined. By applying a compensation based on the determined offsets in a conventional manner, the field becomes square as shown in FIG. 1, detail B.

FIG. 3a depicts a second calibration option for mapping and calibrating the beam-directing device. Here, a reference grid or plate 300, that may be chrome on quartz or some other material, is accurately printed or etched, and placed on the substrate fixture 200 parallel to the X and Y axes of the system. This reference grid 300 provides point locations that can be viewed with a camera.

FIG. 3b shows a top view of the reference grid or plate 300 showing a detail of a cross location 310 on the reference grid 300 and a camera cross hair 320 centered on a crossed location. The beam-directing device positions corresponding to cross point locations for the grid across the scan lens field are taken and used as compensation for the non-linearity in the system.

In conventional laser-trimming systems with through-the-lens camera viewing via the beam-directing device, one problem is that the laser beam and cameras typically are not coaxial. Thus, compensation is required. The only way to determine the location of the beam is to use the first calibration option as shown in FIG. 2a, where marks or lines are created on a sacrificial plate. These marks or lines can then be used as grid locations (FIG. 3a) that the camera can find and from which the offset of the vision subsystem non-coaxiality with respect to the laser beam can be determined. Effectively, a combination of calibration options as shown in FIGS. 2a and 2b and in FIGS. 3a and 3b are used for calibration of both the vision path and the laser beam path in a conventional laser trimming systems.

A major problem with both of these calibration options is that a sacrificial plate 210 or reference grid 300 must be placed into the machine prior to this operation. This requires operator intervention and thus cannot be done in an automated fashion during processing.

Another problem associated with conventional laser trimming systems is that there is a requirement to maintain parallelism of the probe tips relative to the work piece that is being probed during trimming. Thus, once a probe card is installed in the system it must be adjusted for parallelism. FIG. 4a shows a probe card 400 with its probe tips A-E not parallel to the surface of work piece 420 that is being trimmed, or equivalently not parallel to the substrate fixture (not shown) upon which the work piece 420 is mounted. The probe card 400 must be leveled parallel to the substrate fixture in both roll and pitch axes.

FIG. 4b shows the probe card 400 over substrate fixture 430, and the roll and pitch axes. The roll and pitch of the probe card 400 must be aligned in order to make the probe card 400 parallel to the substrate fixture 430. Typically, in conventional systems, this is done manually with knobs that are turned by hand to align the probe card when the probe card is inserted in the system. Furthermore, the probe card pitch and roll is usually aligned using either the eye to determine where the probe tips are relative to the substrate fixture 430 across the probe card 400, or by probing an actual circuit mounted on the substrate fixture and determining when good readings are obtained in the measurement system that is attached onto the probe card.

This aligning is typically an iterative process. First, an adjustment to roll or pitch is made. Then, a measurement(s) are taken. Then, further adjustments are made as necessary, and so on. Additionally, for very fine pitch applications, such as applications requiring the probing of elements on a work piece, it is not possible to visually determine the position of the probe tips since the adjustments are so small. Thus, the planarization alignment process is cumbersome in that it is manual, iterative, and requires significant operator intervention. Further, the accuracy of the results is marginal. High accuracy is important, particularly for finer pitch applications, which require a very high degree of planarization between the probe card and the surface of the work piece.

In any system that uses a probe card with fixed probe tips, in addition to planarization alignment, the probe card must also be aligned in the system for other purposes. FIG. 5 shows a probe card 5000 on top of a circuit 5100 to be probed on a substrate 5150, and depicts probe tips 5200 in relation to the probe circuit 5100 and probe pads 5300 located on the substrate 5150. The pads 5300 are rotated and offset relative to the probe tips 5200 in the system. Conversely, the probe card 5000 is effectively rotated and offset relative to the circuit 5100 on the substrate 5150. The objective of probe card alignment is to correct for this offset and rotation. Typically this is done by using either of two techniques.

In one technique, the vision subsystem looks through a scan lens to determine the location of both the probe tips 5200 and the probe pads 5300. The operator then manually rotates the probe card 5000 and offsets either the position of the circuit 5100 or the probe card 5000 itself relative to the circuit 5100 so that the imaged locations are aligned. In the other technique, the operator manually rotates the probe card 5000 and offsets either the position of the circuit 5100 or the probe card 5000 itself relative to the circuit 5100, in order to make proper contact between the probe tips 5200 and probe pads 5300. This can be checked using a measurement system when the probe card 5000 is in contact with the circuit 5100.

A major problem with these techniques is that the process is manual and iterative and vision subsystems are often not able to see the correct location of the probe tip because they are unable to focus on a probe that is not perfectly planar with the substrate. Thus, conventional techniques for aligning probe card tips with the circuit probe pads require substantial time and operator effort in order to achieve proper alignment.

Another alignment that must be considered is related to the substrate. In particular, and as shown in FIG. 6, a ceramic substrate 600 is typically loaded onto a substrate fixture 610 and typically pushed up against some edge hard stops 620 to define the location of the ceramic substrate 600 on the substrate fixture 610, and hence a location of circuit 630 on the ceramic substrate 600. This substrate alignment may be acceptable for applications where the circuit 630 is aligned well relative to the edges of the ceramic substrate 600. However, in cases where the circuit 630 is rotated or translated relative to the edges of the ceramic substrate 600, some additional alignment correction may be required. In this case, the entire substrate fixture 610 may need to be rotated in theta and translated in the X and Y directions in order to align the circuit 630 with the coordinate system of the machine.

One of the major problems with conventional substrate alignment techniques is that the edges of the printed circuit board (PCB) panel are typically not well defined with reference to the circuits within the edges. Therefore, aligning the panel to edge stops will not greatly improve the alignment of the circuits formed on the panel. A second problem is that the circuits or any underlying components on the underside of the panel are prone to damage if the panel is translated when in contact with the substrate fixture. A third problem is the mechanical difficulty encountered when rotating larger panels mounted on top of an X-Y stage. All of these issues are further exacerbated by large panel sizes typically used in PCB production, which implicates larger substrate fixtures.

Another alignment that must be considered is related to the circuits within a substrate. Typically, the circuits on a substrate are often all laid out in a single orientation within the substrate, as shown in FIG. 7a. The probe card is manufactured and designed to accommodate that particular orientation and the probe card steps across the ceramic substrate 700 to contact with each of the circuits 710, all in the same orientation. If another orientation is selected for the ceramic substrate or a different orientation is selected for the circuits on the ceramic substrate, a different probe card must be designed and inserted into the machine in order to trim all of the circuits on that particular ceramic substrate.

Conversely, FIG. 7b shows a typical PCB panel 720 with circuits A, B, and C laid out on the panel 720 in different orientations. Circuits B are rotated 90 degrees with respect to circuits A, and circuits C are rotated by 180 degrees with respect to circuits A. The circuits A, B and C are identical in all other respects. Orientations of the circuits A, B, and C on the PCB panel are chosen to maximize utilization of the overall PCB area, as well as to equalize copper-sharing, the uniformity of the copper, and other processes performed in PCB production. For conventional systems to handle trimming of the entire PCB panel as shown in FIG. 7b, three different probe cards must be inserted into the machine. This results in down-time and/or operator intervention, and hence lowers the efficiency of the machine processing. Furthermore, this requires the manufacture of three separate probe cards.

Conventional laser trimming systems used in the trimming of substrates for hybrid circuits and chip resistors typically use a step and repeat handler, similar to that shown in FIG. 8. The step and repeat handler 800 includes an X-Y stage 810 which moves over a base plate 820, a Z stage 830 mounted on the X-Y stage 810, a theta stage 840 mounted on the Z stage 830, and a substrate fixture 850 mounted on the theta stage 840, such that the substrate fixture 850 may be movable in X, Y, Z and theta directions. The substrate fixture 850 can be rotated and offset to provide circuit rotation and offset similar to that previously discussed with reference to the probe card alignment as shown in FIG. 5. The Z stage 830 is used for moving the substrate vertically into contact with a fixed probe card (not shown). Substrate alignment, as shown in FIG. 6, is accomplished by using the X-Y stage 810 and theta stage 840 to move the substrate fixture 850 in the X, Y and theta directions. During normal operation, a step and repeat sequence is initiated after alignment of a substrate on the substrate fixture 850, as shown in FIG. 7a, to probe and trim a repeated array of circuits. In this regard, the X-Y stage 810 is indexed in precise intervals to match the spacing of the circuits on the ceramic substrate.

In the conventional step and repeat handler 800, the X-Y stage 810 is typically a linear stepper motor riding on an air cushion over the base plate 820. Both X and Y motions are equivalent in their speed of indexing. Large PCB panels typically contain many circuits that must be indexed under the probe card during trimming. This stepping and repeating between probe sites can account for a large fraction of the overall trim time for processing the panel. The panel fixture is typically fairly large and heavy for large PCB panels, and this weight means that the speed (velocity and acceleration), of the X-Y stage in moving such panels is typically quite slow. Furthermore, the larger travel distance required to cover these large PCB panels causes the accuracy of the X-Y stage 810 movement to degrade as the required movement distance increases. More particularly, the X-Y stage 810 is typically homed in one corner 860 of the base 820. As the stage moves further and further away from that location, there is an accumulation of errors that results in the lowering of the accuracy of movement.

Thus, conventional trimming systems use a step and repeat motion to index probing and trimming sites over a substrate. The time for this step and repeat motion between the trimming/probing locations is overhead that adds to the total process time for the substrate. In the case of small hybrid circuit substrates, the step and repeat motion may not be a significant fraction of the overall process time. However, for large PCB panels, especially where the number of individual probing and trimming sites on the panel is also large, this step and repeat overhead time can become a significant fraction of the total process time. Furthermore, the large size of the PCB panels to be trimmed typically infers a larger and higher mass of the substrate fixture, the movement of which will be at a slower acceleration and velocity than the acceleration and velocity at which a smaller substrate fixture used for convention small substrates can be moved.

There is a need, therefore, for techniques to reduce the move time necessary for the step and repeat motion, and in a more general sense, there is a need for techniques that improve lasing operations.

### SUMMARY OF THE INVENTION

One embodiment of the present invention provides a system for probing circuit elements. The system includes a fixture having a platen surface configured to support a work piece having a target element. A probe holder is configured to support a probe for detecting a characteristic of the target element. A first stage is configured to rotate the probe holder about an axis substantially orthogonal to the platen surface, thereby enabling differently orientated circuits on the work piece to be probed (e.g., O-direction stage). In one such particular embodiment, the probe holder can be rotated through an angle in the range of at least 40 degrees to 280 degrees. A second stage is operatively coupled to the first stage, and is configured to move the probe holder substantially parallel to the axis (e.g., Z-direction stage). A controller is configured to control the first stage (and may also control the second stage), so as to automatically align probe tips of the probe with corresponding probe locations associated with the target element.

The system may further include a third stage that is configured to move the fixture substantially parallel to the platen surface (e.g., X-direction stage). Here, the second stage can be further configured to move the probe holder to a first stop location during loading of the work piece onto the fixture, to a third stop location during third stage movement of the fixture with the work piece loaded on the fixture, and to a second stop location during probing of the target element. The system may further include a fourth stage that is configured to move the fixture in a second direction that is substantially parallel to the platen surface and perpendicular to the first direction (e.g., Y-direction stage).

The system may further include a camera and an emitter configured to emit a beam of light to lase the target element. The camera is positioned to view the target element through the scan lens, wherein the camera has a viewing path that is substantially coaxial with a path of the beam. One such configuration further includes a focus telescope configured to simultaneously maintain optical focus of both the beam and the camera at the target element.

Another embodiment of the present invention provides a system for probing circuit elements. The system includes a fixture having a surface configured to support a work piece having a target element. The fixture includes a calibration subassembly configured to aid automatic calibration during at least one of probe card planarization, probe card alignment, galvo calibration, laser power measurement, and probe tip cleaning. A probe holder is configured to support a probe for detecting a characteristic of the target element. A first stage is configured to rotate the probe holder about an axis substantially orthogonal to the surface, so as to automatically align probe tips of the probe with corresponding probe locations associated with the target element (e.g., O-direction stage). In one such embodiment, the calibration subassembly is accessible even when work piece is mounted on the fixture, thereby allowing real-time automatic calibration procedures to be carried out.

Another embodiment of the present invention provides a system for positioning a work piece for lasing. The system includes a fixture having a surface substantially parallel to a plane and defined by a first axis and a second axis that is orthogonal to the first axis, the surface for supporting a work piece configured with a plurality of different areas disposed thereon, with each area including one or more circuit elements to be lased. A first stage is configured to move the fixture substantially parallel to the plane and the first axis, and a second stage is configured to move the first stage and the fixture substantially parallel to the plane and the second axis. A controller is configured to determine a path for movement between the different areas by directing movement of the first stage and the second stage based on distances along the first axis between each of the different areas and distances along the second axis between each of the different areas, thereby positioning each of the plurality of different areas for lasing the one or more circuit elements included in that area. The controller can be configured, for example, to determine a path for movement that is associated with a travel time that is comparable or shorter than travel time of other possible paths. Thus, optimal lasing procedures can be achieved.

In one such embodiment, the controller is configured to compute total time periods of movement of the first and the second stages to move the work piece respectively along the path based on the distances along the first axis and the distances along the second axis, to compare the computed total time periods, and to direct the movement of the first and the second stages in accordance with a result of the comparison. The system may further include a probe for measuring a characteristic of the one or more circuit elements included in the each area after positioning that area in a lasing position. Here, the controller is further configured to compute rotation of the probe in correspondence with the movement of the work piece along the path, based on the respective angular orientation of each of the plurality of different areas.

The features and advantages described herein are not all-inclusive and, in particular, many additional features and advantages will be apparent to one of ordinary skill in the art in view of the drawings, specification, and claims. Moreover, it should be noted that the language used in the specification has been principally selected for readability and instructional purposes, and not to limit the scope of the inventive subject matter.

### BRIEF DESCRIPTION OF THE DRAWINGS

FIG. 1 depicts a grid of defined cross points addressed by an uncalibrated beam-directing device and a corresponding grid of defined cross points addressed by a calibrated beam-directing device.

FIG. 2a depicts a beam-directing device calibration set up for marking a sacrificial substrate with a beam directed by the beam-directing device.

FIG. 2b depicts a view of the laser marked sacrificial substrate of FIG. 2a as viewed through a vision system.

FIG. 3a depicts a beam-directing device calibration set up for measuring a location of cross points on a reference grid.

FIG. 3b depicts a view of the reference grid of FIG. 3a as viewed through a vision system.

FIG. 4a illustrates a side view of a probe card that is misaligned (planarity error) with respect to a circuit of a PCB panel to be probed.

FIG. 4b depicts the probe card of FIG. 4a supported with pitch and roll adjustments for aligning the probe card to contact the probe tips with the circuit.

FIG. 5 illustrates a top view of a probe card that is misaligned (theta error) with respect to a circuit to be probed.

FIG. 6 illustrates a ceramic substrate that is misaligned with respect to features on a substrate fixture.

FIG. 7a depicts a ceramic substrate having a plurality of substantially identical circuits to be trimmed with each circuit being oriented exactly alike.

FIG. 7b depicts a PCB panel having a plurality of substantially identical circuits to be trimmed with some circuits being oriented in different ways.

FIG. 8 depicts a substrate support and motion system used in step and repeat trimming applications.

FIG. 9a shows a schematic representation of a lasing system configured in accordance with one embodiment of the present invention.

FIG. 9b depicts a stage support assembly of the lasing system of FIG. 9a, configured in accordance with one embodiment of the present invention.

FIG. 9c depicts the box and bridge structure configured in accordance with one embodiment of the present invention.

FIG. 9d depicts details of a linear stage that could be incorporated into the lasing system of FIG. 9a, configured in accordance with one embodiment of the present invention.

FIG. 9e depicts details of a Z-Theta stage that could be incorporated into the lasing system of FIG. 9a, configured in accordance with one embodiment of the present invention.

FIG. 9f depicts a panel fixture that could be incorporated into the lasing system of FIG. 9a, configured in accordance with one embodiment of the present invention.

FIG. 9g demonstrates drawing air through a panel fixture that could be incorporated into the panel fixture of FIG. 9f, in accordance with one embodiment of the present invention.

FIG. 10a depicts a panel fixture that includes a calibration subassembly configured in accordance with one embodiment of the present invention.

FIG. 10b depicts a glass calibration plate mounted on a panel fixture, in accordance with one embodiment of the present invention.

FIG. 11a depicts a cross sectional view of a calibration aperture and detector used for determining a position of the laser beam, configured in accordance with one embodiment of the present invention.

FIG. 11b depicts a plan view of the calibration aperture of FIG. 11a.

FIG. 11c depicts a graphical representation of an example detector signal, output by the detector shown in FIG. 11a, which can be used to locate the laser beam center.

FIG. 11d depicts an example plurality of calibration apertures which can be used to calibrate the laser beam position over an entire scan field, in accordance with an embodiment of the present invention.

FIG. 11e is a flow diagram of a calibration process in accordance with one embodiment of the present invention.

FIG. 11f depicts a cross sectional view of a calibration aperture and detector that can be used to carry out the process of FIG. 11a, but which is movable by a Z-stage, in accordance with another embodiment of the present invention.

FIG. 12 depicts a side view of a probe card and probe card planarization plate with a plurality of probe tips not in contact with a probe card planarization plate.

FIGS. 13a and 13b depict a probe card mounting that provides roll and pitch adjustment of the probe card with respect to the probe card alignment plate in accordance with one embodiment of the present invention.

FIG. 14a depicts an example probe card alignment plate configured in accordance with one embodiment of the present invention.

FIG. 14b depicts a plurality of probes in contact with the probe card alignment plate of FIG. 14a after proper alignment, in accordance with one embodiment of the present invention.

FIG. 15a depicts the vision system of FIG. 9a having coarse and fine field cameras, in accordance with one embodiment of the present invention.

FIG. 15b depicts the vision system of FIG. 9a having a single fine field camera, in accordance with another embodiment of the present invention.

FIG. 15c illustrates an example of an image captured by the vision system.

FIG. 15d illustrates an LED illumination system configured in accordance with one embodiment of the present invention.

FIG. 16a depicts a PCB panel placed on the panel fixture in an unknown orientation.

FIG. 16b depicts a PCB panel with coarse fiducial marks for globally determining panel position and fine fiducial marks for locally determining circuit position, in accordance with an embodiment of the present invention.

FIG. 16c depicts multiple PCB panels mounted on a panel fixture, in accordance with an embodiment of the present invention.

FIG. 17 depicts a step and repeat sequence for moving a panel to position each circuit to be lased, in accordance with one embodiment of the present invention.

FIG. 18a depicts a motion sequence for moving a panel to a different x-position, in accordance with one embodiment of the present invention.

FIG. 18b depicts a velocity profile for the z-motion, in accordance with one embodiment of the present invention.

FIG. 19 depicts a laser optical system including a focusing telescope for focusing the optical system at a target surface of a panel, which could be incorporated into the lasing system of FIG. 9a, in accordance with one embodiment of the present invention.

FIG. 20a depicts element material to be lased and copper fiducials on a panel with the element material located relative to copper circuit patterns.

FIG. 20b depicts an element to be lased that is not in its expected position.

### DETAILED DESCRIPTION OF THE INVENTION

Embodiments of the present invention enable calibration of a vision subsystem and/or a laser beam in a lasing system without the use of a sacrificial plate or a reference grid or plate, and without operator intervention and in a substantially automated fashion. Planarization of the probe card and the surface of the work piece is enabled with a high degree of accuracy, and in a less cumbersome manner relative to conventional techniques. Proper alignment of probe card tips with circuit probe pads can be achieved more quickly and more easily. Likewise, accurate alignment of circuits or circuit elements on a panel or other substrate without damage to circuits or elements on the underside of the substrate and/or without the need to rotate the substrate is enabled. Also, efficient lasing of different circuits laid out on a single substrate with different orientations is enabled. In a more general sense, the disclosed techniques can be employed to reduce overall lasing time for processing a effectively, and to improve the accuracy of the probing and lasing required in processing a panel or other substrate.

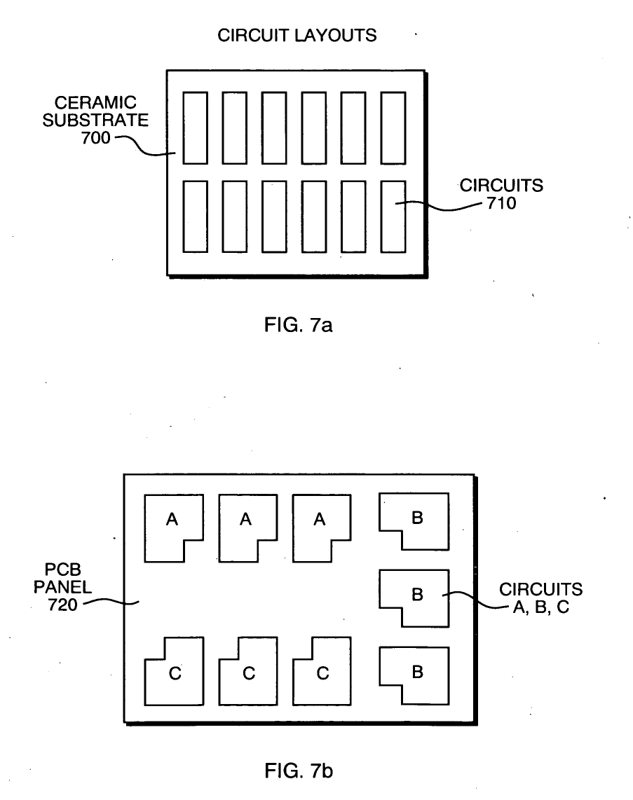

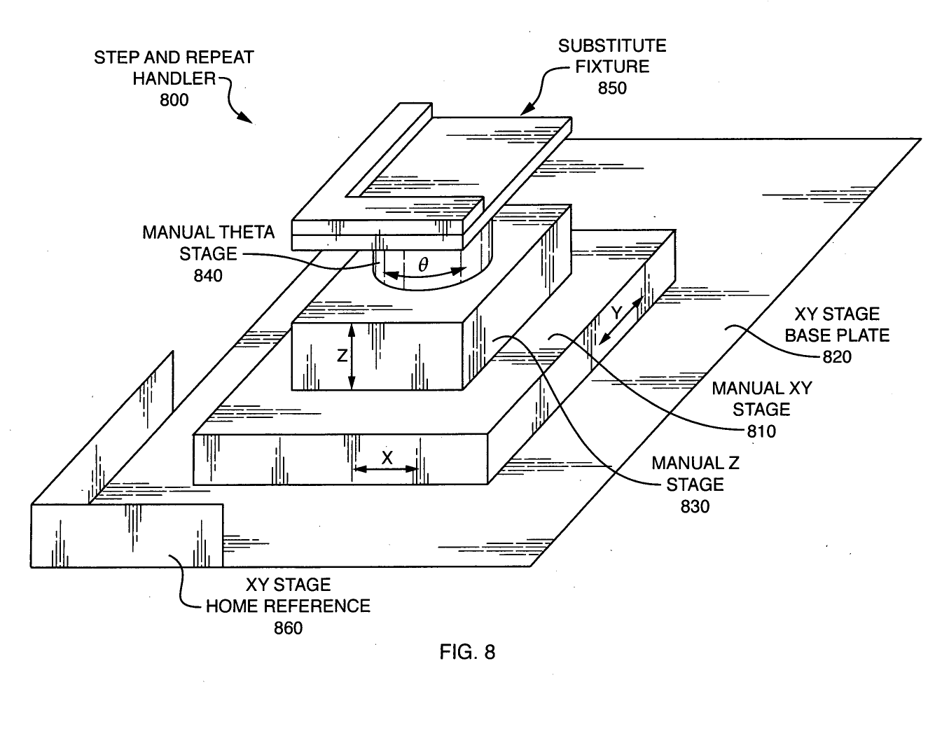

A panel typically includes at least one untrimmed circuit or other target element formed thereon. A target element may include, for example, a resistor, capacitor or inductor formed contiguous with dielectric or conductive layers, or both. The target element may also include a portion of the dielectric layer or a portion of the conductive layer, or both, as is the case for an untrimmed embedded capacitor. A panel typically includes other features as well, such conductive paths that are operatively coupled or otherwise part of electronic circuitry. Note that such electronic circuitry may be added to the panel before or after the trimming of the target elements. In addition, recall that a panel may be effectively used as a substrate for forming a plurality of substantially identical circuits, formed in a repeated pattern on the panel as shown in FIG. 7a. Alternatively, a panel may be effectively used as a substrate for forming a plurality of different circuits formed in a pattern thereon, or a plurality of substantially identical circuits formed in different orientations thereon as shown in FIG. 7b. Alternatively, a panel may be effectively used as a substrate for forming a single circuit (e.g., a computer mother board).

Lasing System Architecture

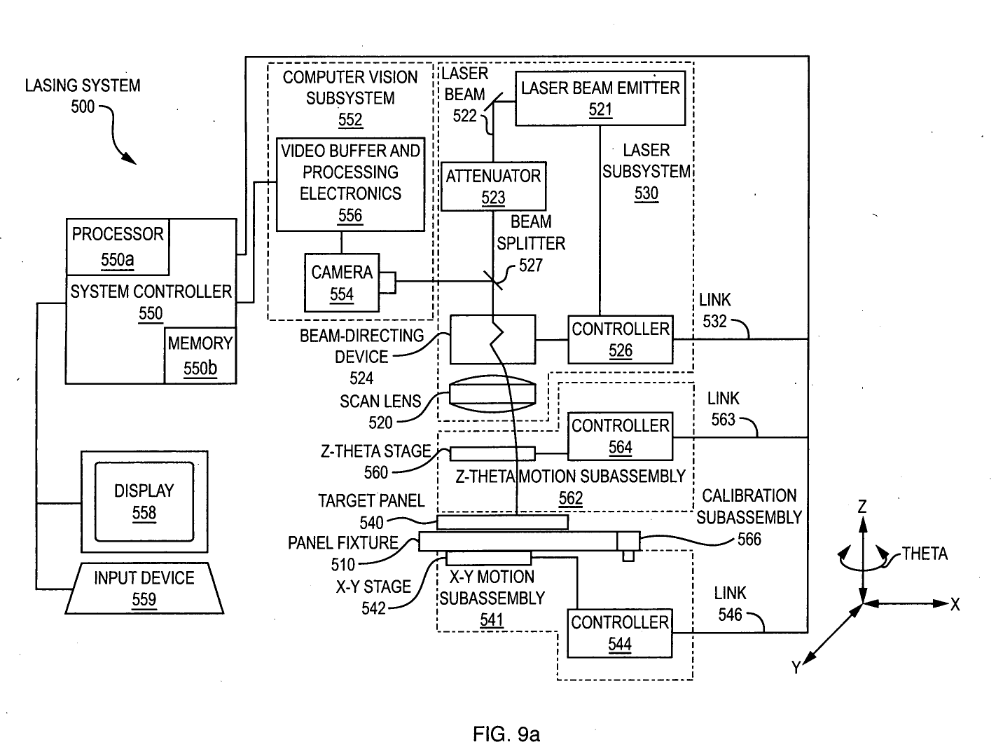

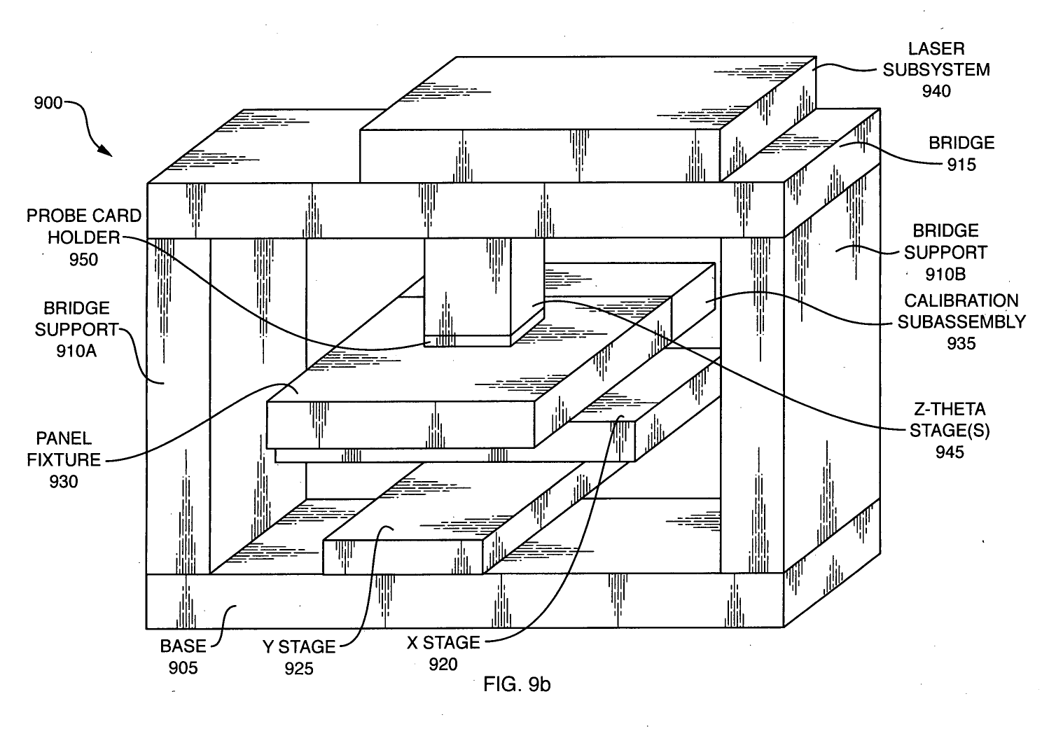

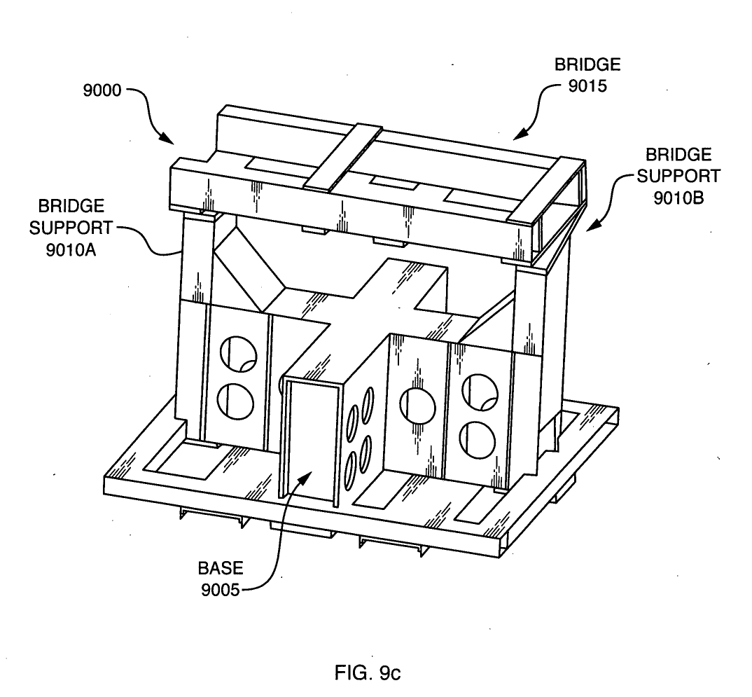

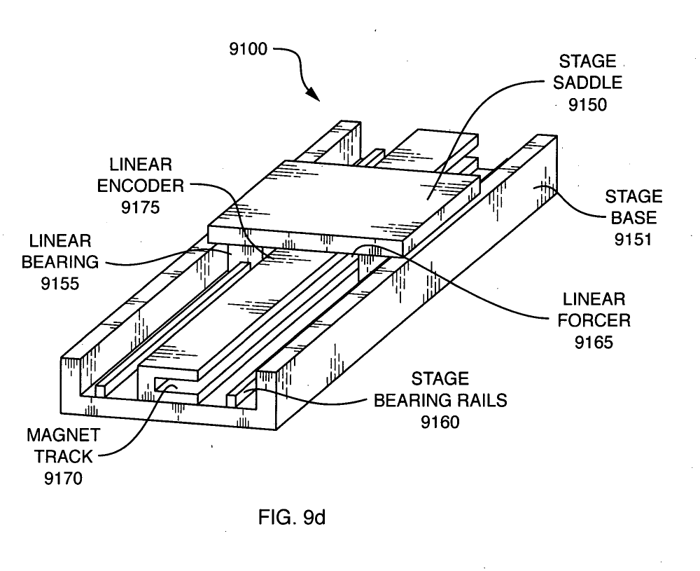

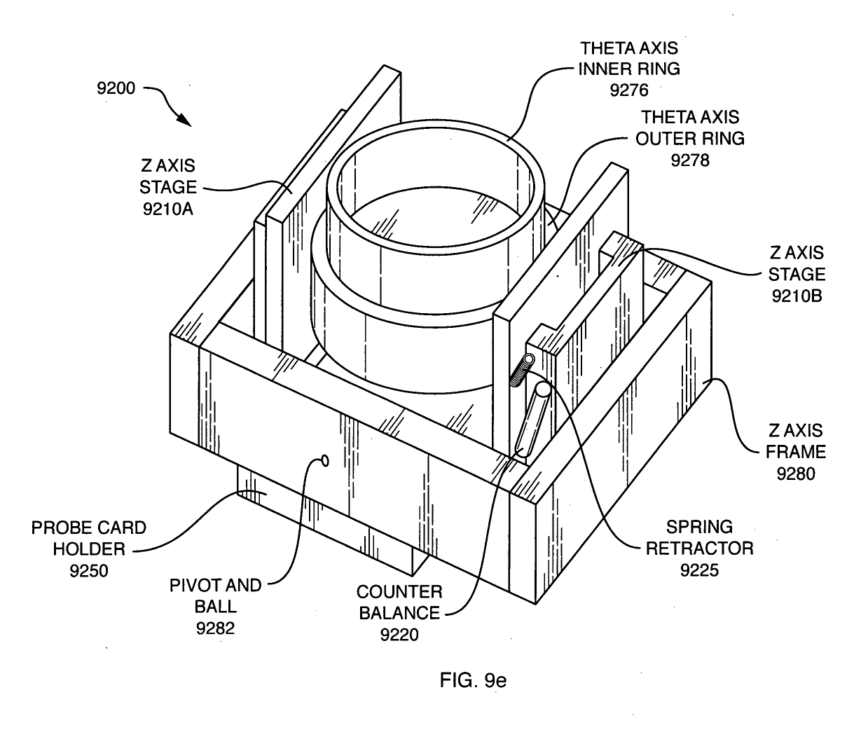

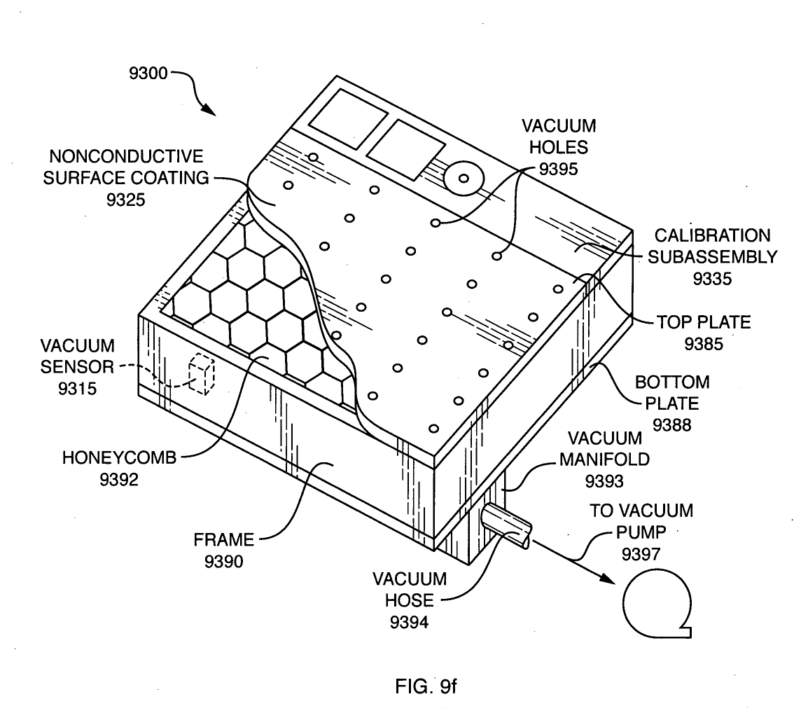

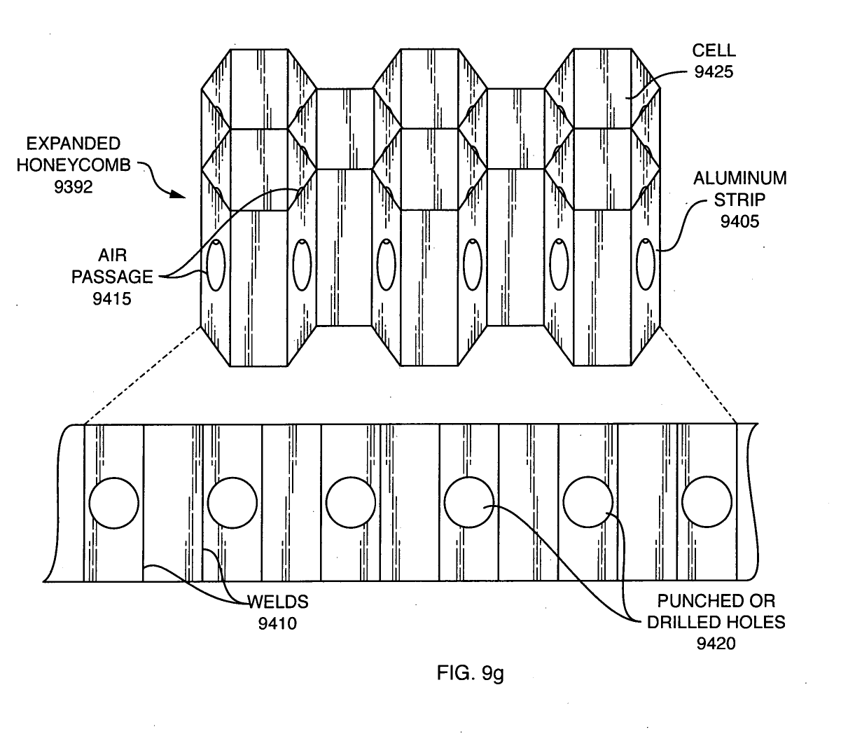

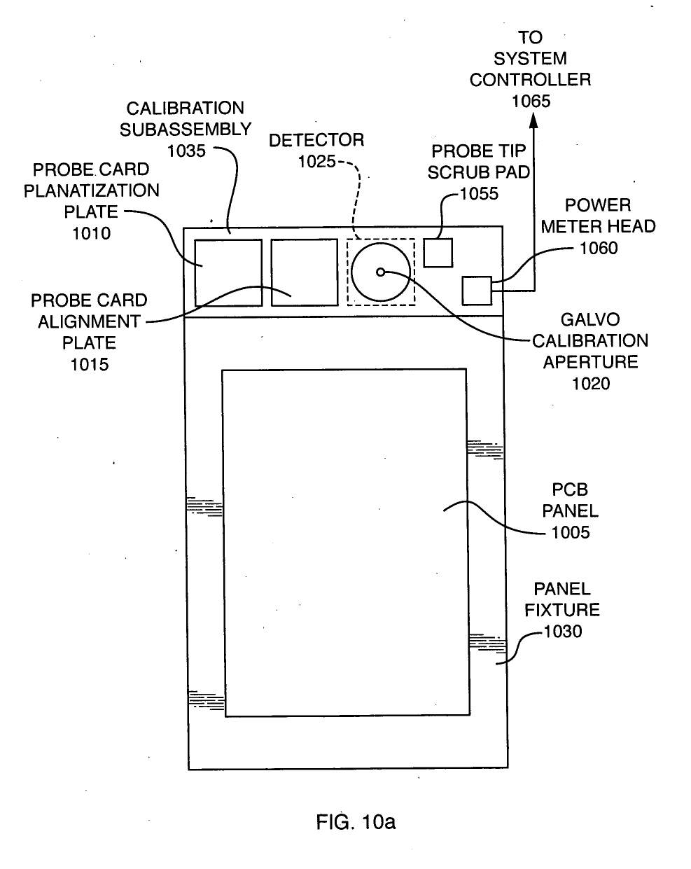

FIG. 9a depicts a system 500 configured in accordance with an embodiment of the present invention, for lasing target circuit elements formed onto a panel such as a substrate or printed circuit board (PCB), or other type work piece. The system includes a system controller 550, a computer vision subsystem 552, a laser subsystem 530, a Z-Theta motion subassembly 562, a panel fixture 510, an X-Y motion subassembly 541, and a calibration subassembly 566. A target panel 540 is shown in place on the panel fixture 510, and a video display device 558 and input device 559 allow an operator to interface with the system.

Laser Subsystem

The laser subsystem 530, outlined in phantom, is for directing a laser beam 522 onto a surface of the panel 540 to trim or otherwise laser an element formed thereon. The laser subsystem 530 includes a laser beam emitter 521 and a beam-directing device 524 capable of directing the laser beam 522 over a selected region of the panel 540. An attenuator 523 and beam splitter 527 are coupled between the beam emitter 521 and the beam-directing device 524. The attenuator 523 can be used to decrease the laser power when desired (e.g., during a calibration sequence), and the beam splitter 527 splits the emitted beam 522 so that the beam travels to both the beam-directing optics and the computer vision subsystem 552. The laser subsystem 530 also includes a lens 520 positioned in the path of the laser beam 522, between the laser beam emitter 521 and the panel 540, for focusing the laser beam 522 to a desired spot size at the surface to be lased. The field of the lens 520 may range, for example, from about 1.0 inch in diameter up to about 8 inches in diameter. In one particular embodiment, the lens 520 has a field of view that allows the laser beam 522 to be directed over about a 2 by 2 inch to a 4 by 4 inch region of the panel 540. In this sense, the field of view of the laser subsystem 530 is defined by the design of the lens 520, which allows a focused beam to address any selected position within the field of view for processing target elements within a region of the panel that is positioned in the lens field of view.

The laser subsystem 530 may also include one or more laser subsystem controllers 526 for controlling the position, velocity and power output of the focused laser beam 522 during lasing, as well as during periods when the laser is not lasing. In this particular embodiment, the field of view of lens 520 is smaller than the panel 540 size. Therefore, in one operational sequence, all of the elements within the field of view are lased without moving the panel 540, and then the panel 540 is moved with respect to the field of view to position the next target portion of the panel 540 in the field of view for lasing. In one particular embodiment, the lens 520 is configured as a telecentric lens, and the beam-directing device 524 is positioned substantially at an entrance pupil of the lens 520 so that the laser beam 522 impinges substantially normal or perpendicular to the surface to be lased over the entire field of view of the lens 520.

Accordingly, the laser subsystem 530 emits a lasing beam that is focused substantially at a surface of a target element disposed on the panel 540 and has sufficient power to precisely remove or otherwise process the material of the that element in a controlled manner. The position of the laser beam 522 emitted by the laser subsystem 530 can be changed to impinge on elements anywhere within the field of view of the lens 520. The motion and modulation of the laser beam 522 is controlled by laser control signals issued by the laser subsystem controller 526. The laser subsystem controller 526 can be implemented, for example, as a programmable microcontroller unit including at least one processor, memory, I/O capability, and a number of functional processes (e.g., lasing algorithms associated with a number of different laser trimming applications) as will be apparent in light of this disclosure.

The desired positions and motion characteristics of the laser beam 522 are identified by signals received by the laser subsystem controller 526 from the system controller 550 over a connection 532, which can be any type of communications link. The system controller 550 directs the operation of the entire system 500. The system controller 550 includes at least one processor 550a and at least one memory 550b for storing programming and other data (e.g., calibration data). Memory 550b, as well as other memories described herein, can be any type memory, including, but not limited to, random access, floppy disk, hard disk, and/or optical disk. As shown in FIG. 9a, memory 550b is part of the system controller 550. Alternatively, the memory 550b could be separated from and linked to the controller 550 by a communications link. The system 500 also includes a keyboard 559, and/or any other types of operator input devices that are desired, such as a mouse, touch screen or pad, or control panel.

The controllable laser subsystem 530 may be of any type, but generally includes a laser beam emitter 521 that emits an energy beam at a wavelength that is compatible with the type of lasing being performed. The emitter 521 may be, for example, a laser light generator or an optical fiber or any other element capable of emitting a laser beam configured for carrying out the desired lasing process. For example, if a dielectric material is primarily being trimmed, a CO₂ laser that emits a beam at a wavelength of approximately 9-11 μm can be used. If a conductive or resistive layer or circuit element is being trimmed, a solid state laser that emits a beam at a wavelength of approximately 1.06 μm can be used. If the trimming is a photochemical process, the laser wavelength may be visible or ultraviolet light, such as that produced by a beam having a wavelength of approximately 533 nm and shorter. Selection of wavelength will be vary from one embodiment to the next as will be apparent in light of this disclosure, and the present invention is not intended to be limited by any one configuration.

The beam-directing device 524 may be any type of scanning device for moving a laser beam over a two dimensional region. In one particular embodiment, the beam-directing device 524 is implemented with a pair of orthogonally mounted galvanometer mirror scanners (sometimes referred to as galvos herein) as conventionally done. In one such embodiment, each galvanometer mirror scanner includes an angular position transducer for tracking the angular position of the mirror, and a servo driver for controlling the angular rotation of each deflecting mirror to direct the laser beam 522 to a desired position.

Note that in the embodiment illustrated in FIG. 9a, the driving controls for the laser beam emitter 521 and the beam-directing device 524 are included in the laser subsystem controller 526, which is in-turn controlled or otherwise configured by the system controller 550. However, if desired, these controls could be provided directly from the system controller 550 or another controller external to the lasing system 500. In such an embodiment, the laser subsystem controller 526 could be eliminated.

Vision Subsystem

In order to view the panel 540, a computer vision subsystem 552 is provided to measure or determine a location of or to otherwise view an element in the camera field of view. Here, the vision subsystem 552 includes a video camera 554, and a video frame buffer and video image processing electronics 556. The vision subsystem 552 may be incorporated within, or be separate from and in communication with, the system controller 550. The vision subsystem 552 is positioned to view the panel 540 through the scan lens 520 such that the video camera 554 captures images within the field of view of the lens 520. The field of view of the camera, which is substantially smaller than the field of the scan lens 520, is positioned within the field of view the scan lens 520 using, for example, galvos included in the beam-directing device 524.

The images may be captured at rates, for instance, of about 30 frames per second to continuously update the image in the field of view. The images may be displayed on a video display device 558 for viewing by an operator. Alternatively, the images may be captured, stored and analyzed by the video image processing electronics 556 or the system controller 550, thereby providing a machine vision function to eliminate operator intervention. In this regard, the vision subsystem 552 in combination with the system controller 550 can be used to determine a location of any element or feature on the panel 540 according to known algorithms. More particularly, the processor 550a operates in accordance with programmed instructions, which implement one or more known algorithms and are stored in memory 550b, to process image data from the vision subsystem 552 to determine the applicable location.

Image data from the vision subsystem 552 may be used to select and/or inspect circuit elements on the panel 540. The vision subsystem 552 may also be used to capture images of one or more alignment targets, such as fiducials, on the panel 540 or on the panel fixture 510, to provide information about the position of the panel 540 so that targeted lasing can be carried out. In any case, images of the targeted areas may be used to determine a position or angular orientation of the panel 540 with respect to a system reference position or orientation.

Likewise, images of alignment targets and/or circuit elements may be used to determine a position of an object within the field of view of lens 520, and to direct the laser beam 522 in accordance with the determined positioning of the object. Image data from the vision subsystem 552 may also be used to determine if the correct panel 540 has been loaded onto panel fixture 510, if the targeted elements appear to be properly applied onto the panel 540, and if lased elements meet a predefined trim criteria such as whether the laser cut is properly positioned with respect to any edges or other features of the target element. Furthermore, image data from the vision subsystem 552 may be used to determine a position or condition of a measurement probe or probes, as will be described in-turn.

An error condition detected by the vision subsystem 552, or image data from which such an error condition can be determined, may be communicated to the system controller 550 where a logical decision can be made to either correct the error or to take some other automatic action in response to the error condition, including stopping the lasing operation. Note that the vision subsystem 552 itself may include logic for image processing operations, or may pass image data to the system controller 550 for image processing operations.

X-Y Motion Subsystem

The X-Y motion subassembly 541 of the lasing system 500 includes an X-Y stage 542 and an X-Y stage controller 544. The panel 540 is supported by the panel fixture 510, which is supported by the X-Y stage 542. Thus, the panel fixture 510 is movable by the X-Y stage 542 in the X and Y directions, in accordance with X-Y stage control signals issued by the X-Y stage controller 544. The control signals issued by the X-Y stage controller 544 are based on directives received from the system controller 550 via a connection 546, which may be any type of communications link. Stage controller 544 can be implemented in conventional technology, such as a processor and memory (e.g., programmable microcontroller unit or special purpose processing environment, such as ASIC or FPGA).

The stage 542 may also be implemented in conventional technology and includes, for example, a stepper or linear motor drive, or a ballscrew, belt or band assembly driven by a rotary motor, or by some other type drive mechanism. In any event, the stage 542 provides precision X-Y positioning of the panel 540 with respect to a reference position which could, for example, be the center of the field of view of the lens 520. By moving the panel fixture 510, different areas of the panel 540 can be positioned within the field of view of the lens 520. Alternatively, the panel fixture 510 may be held in a stationary position during trimming. In this case, the entire laser subsystem 530 and vision subsystem 552 may be mounted onto an X-Y stage 542. Here, the laser and vision subsystems 530 and 552 can be positioned over different portions of the panel fixture 510 to place the field of view of lens 520 over a region of the panel 542 targeted for trimming or other type of lasing.

Z-Theta Motion Subsystem

The Z-Theta motion subassembly 562 of lasing system 500 includes Z-Theta stage 560 and a Z-Theta stage controller 564. A probe card holder (not shown) for supporting a probe card (not shown) is mounted on the Z-Theta stage 560. As will be understood in light of this disclosure, a probe card can be used to probe circuit elements disposed on the surface of the panel 540. The probe card holder, and hence the probe card, is movable by the Z-Theta stage 560 in the Z and Theta directions, in accordance with Z-Theta stage control signals issued by the Z-Theta stage controller 564. The control signals issued by the Z-Theta stage controller 564 are based on directives received from the system controller 550 over a connection 563 which may be any type of communications link. Stage controller 564 can be implemented in conventional technology, such as a processor and memory (e.g., programmable microcontroller unit or special purpose processing environment, such as ASIC or FPGA).

The Z-Theta stage 560 may also be implemented in conventional technology and includes, for example, a stepper or linear motor drive, and/or a ballscrew, belt or band drive assembly driven by a rotary motor, or by some other type drive mechanism. In any event, the Z-theta stage 560 provides precision Z-Theta positioning of the probe card with respect to a reference position such as, for example, the center of the field of view of the lens 520. By moving the Z-Theta stage 560, and thereby moving the probe card holder and probe card, the probe card can be positioned over different portions of the panel 540 for probing.

Stage Support Assembly

As depicted in FIG. 9b, an embodiment of a stage support assembly 900, for incorporation into the lasing system 500 of FIG. 9a, includes a base 905 and a pair of bridge supports 910A, 910B attached thereto and supporting a bridge 915. An X stage 920 and a Y stage 925 are mounted on the base 905, with the X stage 920 in this embodiment, mounted on to the Y stage 925. Note that this configuration of the X and Y stages could be reversed if so desired. A panel fixture 930 is mounted on the top of the X stage 920, and a calibration subassembly 935 is either mounted to the panel fixture 930 or is mounted within or otherwise a part of the panel fixture 930. Bridge supports 910A, 910B are used to support the bridge structure 915 which in turn supports a laser subsystem 940, the Z-Theta stage 945, a probe card holder 950, and optionally the vision subsystem (not shown in FIG. 9b).

In one embodiment, the laser subsystem 940 includes a laser emitter, galvanometers, and a scan lens similar to those described above with reference to laser subsystem 530 of FIG. 9a. The Z-Theta stage 945 provides vertical and rotary motion of the probe card holder 950 which, in turn, holds a probe card (not shown) for use during trimming and probing operations. X and Y motion of the panel fixture 930 with respect to the probe card and laser subsystem 940 is affected using the X stage 920 and Y stage 925. The X and Y stages 920 and 925 thus serve to position a desired region of the panel fixture 930 under the laser subsystem 940 and the probe card supported by the probe card holder 950 and Z-Theta stage 945.

FIG. 9c depicts one embodiment of a support structure 9000 having a base 9005, bridge supports 9010A and 9010B and bridge 9015. The frame 9000 can be utilized in the stage support assembly 900 of FIG. 9b. The frame base 9005 is designed in a t-shape for supporting the X and Y stages (not shown) and the bridge supports 9010A and 9010B. The t-shape base 9005 serves to provide stiffness between the stage mounting and bridge supports while allowing for the mounting of system components (e.g., system controller 550) substantially within the envelope of the panel fixture motion. This configuration allows for a compact machine platform that minimizes the floor area required.

In one particular embodiment, the frame 9000 including base 9005, bridge supports 9010A and 9010B, bridge member 9015, and all of the equipment mounted thereon is designed with a fundamental resonant frequency of >50 Hz. This minimum resonant frequency is chosen to be greater than the typical frequencies present in the acceleration profiles for the X, Y, Z, and Theta stages. This serves to prevent the excitation of resonant modes by the motion of the stages, which could otherwise lead to ringing and other oscillations in the machine structure causing increased motion stage settling times and decreased accuracy of the laser subsystem position relative to the panel during processing.

In one embodiment, the frame structure 9000 is designed as a series of box sections fabricated from welded steel plate. The box sections represent very stiff construction elements that resist shearing, bending and twisting moments (e.g., torsion) and can be beneficially used wherever appropriate, as will be apparent in light of this disclosure. The stiffness of the box sections is such that the fundamental resonance of the overall structure is greater than 50 Hz. Steel is chosen for one embodiment, because of its excellent thermal expansion properties, and high joint strength when welded. Furthermore, the weight of the box sections, and hence the entire frame structure 9000, is reduced by the presence of holes or cut-outs, as shown in the side walls. The cut-out locations are chosen such that the removal of material in the cut-outs does not significantly reduce the stiffness of the box section along the relevant planes of stress within the frame structure 9000. The analysis of resonant frequencies for this frame embodiment is readily accomplished using established techniques such as finite element analysis (FEA) and well known mechanical engineering design and modeling tools and techniques.

FIG. 9d depicts an embodiment of a stage 9100, which could serve as either the X stage 920 or the Y stage 925 of FIG. 9b or from a part of the X-Y stage 542 of FIG. 9a. The stage 9100 includes a stage base 9151. A stage saddle 9150 moves along linear bearings 9155 on stage bearing rails 9160 and is forced using a linear forcer 9165 within a magnet track 9170 to exercise the motion. A linear encoder 9175 is also included for feedback to an X-Y stage controller (not shown), such as controller 544 of FIG. 9a. The magnet track 9170 and linear forcer 9165 combination could alternatively be a rotary motor and ball screw, or some other drive mechanism, if so desired. X and Y stages, of the type shown in FIG. 9d, are stacked, one on top of the other. In this embodiment (as shown in FIG. 9b), both stages act independently, with the X stage being mounted on the stage saddle 9150, and the Y stage being mounted to the base 9151.

FIG. 9e depicts an embodiment of Z-Theta stage 9200, which could serve as the Z-Theta stage 945 of FIG. 9b or 560 of FIG. 9a. Here, theta axis inner ring 9276 is a fixed cylindrical ring that is mounted to the bridge 915 of FIG. 9b or 9015 of FIG. 9c, using bolts or some other attachment scheme. A theta axis outer ring 9278 rotates about the theta axis inner ring 9276 on ball bearings to move the probe card holder 950 in the theta direction. The outer ring 9278 is driven by a linear motor forcer (not shown). The Z-Theta stage 9200 sends position feedback to a Z-Theta stage controller, such as Z-Theta stage controller 564 of FIG. 9a, using a linear encoder similar to that described with reference to FIG. 9d.

On the Theta stage outer ring 9278 are mounted two Z axis stages 9210A and 9210B. These two Z stages operate concurrently to move a Z axis frame 9280 vertically and thereby move the probe card holder 9250 in the Z direction. The Z axis stages 9210A and 9210B are slaved together such that the force is equalized on the two sides of the Z axis frame 9280 so as to prevent distortion of the frame 9280 and non-parallel movement of the probe card holder 9250 relative to a panel fixture, such as the panel fixture 930 of FIG. 9b or the panel fixture 510 of FIG. 9a. The probe card holder 9250 in FIG. 9e is mounted to the Z axis frame 9280 using a pivot and ball 9282. The Z axis stages 9210A and 9210B can be similar to the stages shown in FIG. 9d, incorporating linear motors, bearings, and saddle and stage base as shown in FIG. 9d. The difference between Z axes stages 9210A and 9210B and the X and Y stages is the size of the motors and the travel distance of the stages. Note that, if desired, the two slaved Z axis stages could be replaced by a single Z axis, also mounted to the outer theta stage ring 9278.

Due to the mass of typical Theta stages, it may be advantageous in some embodiments to fix the theta axis stage to the frame and mount the Z direction motion components to the Theta stage outer ring 9278. However, in other embodiments it may be desirable for the Theta stage to be mounted to one or more Z stages, as shown in FIG. 9e. Regardless of the configuration of the Z and Theta stages, it is beneficial to provide a spring retractor 9225 to spring load the Z axis stages 9210A and 9210B, as well as to retract the Z axis stages 9210A and 9210B in the event of an interlock condition, emergency stop, or power failure. This retraction will minimize any damage to the subsystem components and probe card through collision with the panel and/or panel fixture.

Additionally, to minimize the required power applied to the Z axis stages 9210A and 9210B to overcome the weight of these stages, they may be provided with an upward acting counterbalance 9220. In one such embodiment, the counterbalance includes a pneumatic cylinder as shown with the balancing force provided by air pressure controlled through a regulator (not shown). Alternatively, a mechanical linkage (not shown) could also be used to provide the mass counterbalancing force.

Panel Fixture

FIG. 9f depicts an embodiment of a panel fixture 9300 which could serve as the panel fixture 930 of FIG. 9b or panel fixture 510 of FIG. 9a. The panel fixture 9300 has components constructed, for example, of aluminum, and includes a top plate 9385, a bottom plate 9388 and a frame 9390. Sandwiched between the bottom plate and the top plate is a honeycomb structure 9392 that serves to stiffen the panel fixture 9300 while introducing very little mass.

The panel fixture 9300 can be assembled using epoxy adhesive or equivalent, because of its vibration damping properties, but other assembly techniques could also be used if so desired. As shown in FIG. 9g, one embodiment of the honeycomb structure 9392 is made from a series of flat aluminum strips 9405 or other type member with alternating welded joints 9410 between sections. The structure is then expanded to form the hexagonal cells 9425. Holes 9420 are drilled or punched in the structure prior to expansion so that each cell in the expanded honeycomb structure 9392 is formed with an interconnecting air passage 9415. This passage allows vacuum pressure to spread throughout the assembled fixture 9300, even though the vacuum is only introduced at a small area corresponding to a limited number of the honeycomb cells by, for example, a vacuum manifold 9393 as shown in FIG. 9f.

FIG. 9f shows the vacuum manifold 9393 and a vacuum hose 9394 that connects to a vacuum pump 9397. Air flowing through the vacuum manifold 9393 is drawn from vacuum holes 9395. The vacuum at vacuum holes 9395 serves to hold down the panel when mounted on the panel fixture 9300. As an alternative to vacuum holes, the top plate 9385 of the panel fixture 9300 may be constructed from a porous material that allows air to flow into the interior of the fixture. The air flow requirements for the vacuum to hold down a panel with sufficient force depend upon the size and weight distribution of the panel. An area of the vacuum holes or surface in the case of a porous top plate, may not be covered by the panel due to the presence of holes or other cut-outs in the panel, or due to a clear margin surrounding the panel which allows for tolerance in the placement of the panel on the panel fixture 9300. Thus, it may be beneficial for the system controller (e.g., system controller 550 of FIG. 9a) to monitor the vacuum pressure in the panel fixture when the vacuum is applied, and control the vacuum to adjust the flow to thereby achieve the desired vacuum pressure. The vacuum pressure in the panel fixture 9300 may be determined by a signal from a vacuum sensor 9315 disposed within the frame 9390, vacuum hose 9394, manifold 9393 or some other portion of the fixture 9300. Vacuum pump 9397 may be speed controlled as directed by signals from the system controller. Alternatively, a variable valve (not shown) may be employed between the vacuum pump 9397 and the air manifold 9393 to control the vacuum pressure as directed by signals from the system controller.

The construction of the panel fixture 9300 shown in FIG. 9f provides for a high stiffness, low mass surface that is stable and flat for mounting of a PCB panel during processing. To obtain the required flatness, it may be necessary to machine the top surface of the panel fixture 9300 after assembly. This machining operation may be accomplished by milling, grinding, polishing, or some other technique. The flatness requirement of the fixture will depend on the depth of focus of the laser subsystem, but typical values would be in the range of 0.0001″ per foot to 0.1″ per foot.

The top surface of the fixture 9300 may also be coated with a suitable coating 9325 for contact with the PCB panel. Typically, a controlled resistance coating is desired, since the elements disposed on the surface of the PCB are electronic. Such coating 9325 provides sufficient electrical isolation to avoid shorting electrical elements during the lasing process. At the same time, coating 9325 can be configured to prevent the build up of static charge on panel and/or the fixture. Static charge may affect measurements by the probe during trimming, or possibly damage the system or panels themselves. Typical coating resistivities lie in the range 10⁶ ohms to 10¹² ohms, and may be applied by laminating a polymer sheet to the platen surface of the top plate 9385 of fixture 9300. This high resistivity allows for dissipation of static charges while preventing significant electrical conduction between elements disposed on the panel bottom surface, or between those elements and the panel fixture 9300 itself, that could influence the trimming process. The coating 9325 should balance friction, electrical properties, and mechanical durability. In applications requiring a high degree of surface flatness, the thickness variations in the coating 9325 may be further reduced by final lapping and/or polishing.

The low mass of this embodiment of the panel fixture 9300 shown in FIG. 9f serves to increase the acceleration and velocity capability of, in particular the X stage, but also the Y stage, for example X-Y stages 920 and 925 of FIG. 9b or 542 of FIG. 9a, during the step and repeat operation of the machine.

Calibration Subassembly

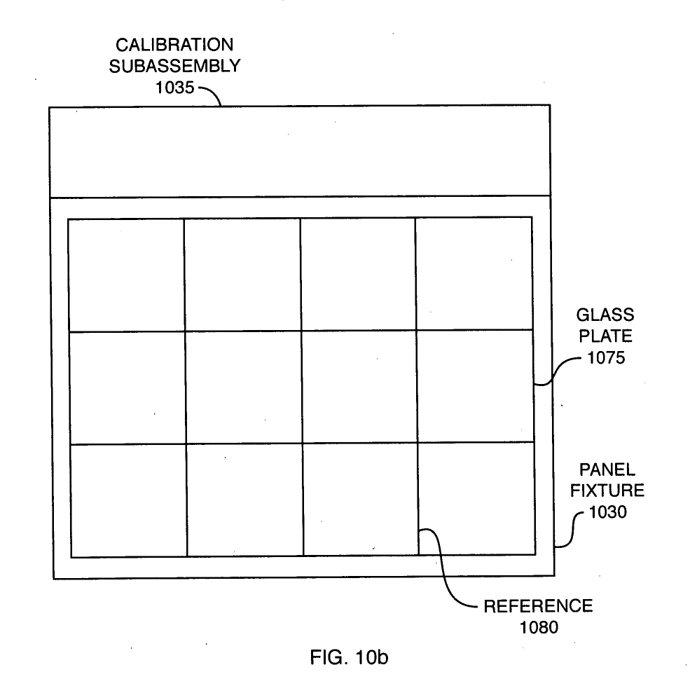

As shown in FIG. 9f, the panel fixture 9300 includes a calibration subassembly 9335. FIG. 10a shows a top view of a panel fixture 1030 having one embodiment of a calibration subassembly 1035, which could serve as the calibration subassembly 9335 of FIG. 9f. The calibration subassembly 1035 is mounted to, or formed as an integral part of, an end of the panel fixture 1030. As shown, a PCB panel 1005 rests on the panel fixture 1030.

The calibration subassembly 1035 includes sub-modules that function as calibration aids during probe card planarization, probe card alignment, galvo calibration and laser power measurement. The calibration subassembly 1035 also aids in probe tip cleaning. More specifically, a probe card planarization plate 1010, a probe card alignment plate 1015, a galvo calibration aperture 1020, a power measurement head 1060 and a probe tip scrub pad 1055 are disposed on the calibration subassembly 1035, so as to be accessible even when the PCB panel 1005 is mounted on the panel fixture 1030. A detector 1025, such as a photodiode or charged coupled device (CCD), is mounted immediately below the calibration aperture 1020. Note that the detector 1025 may form part of the calibration subassembly 1035 or could be an entirely separate element, is so desired. Note that the sub-modules of the calibration subassembly 1035 are in substantially the same plane as the top surface of the panel fixture 1030.

Focus Adjustment Calibration

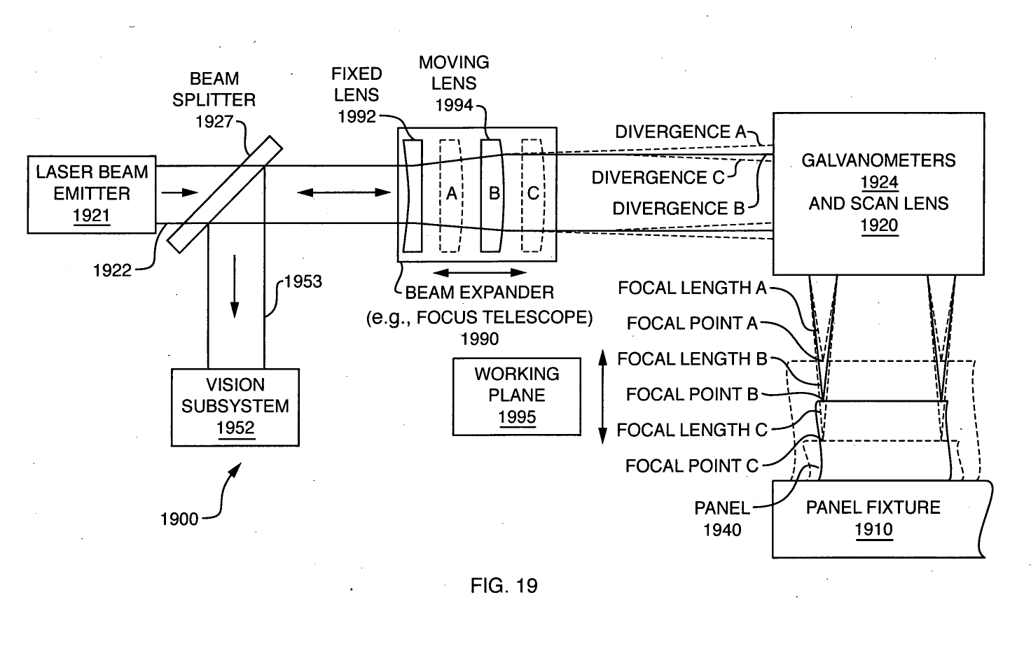

FIG. 19 depicts another embodiment of a trimming/lasing system configured in accordance with another embodiment of the present invention. Here, the system is similar to that shown in FIG. 9a, but further includes a mechanism for changing the Z axis position, i.e., the height, of the panel fixture 510 or the scan lens 520. Such Z axis adjustment can be used, for instance, to maintain optical focus of both the laser and the vision subsystems at the trimming surface. For example, it may be necessary for the trimming system to compensate in this respect for changes in thickness of the panel on the panel fixture. Such thicknesses may differ from one batch of panels to another or, due to manufacturing tolerances, within a batch, or even across a single panel.

Thus, the lasing system 1900 shown in FIG. 19 provides a beam expander 1990 to adjust the focal position of the laser beam 1922 on a panel 1940 supported by a panel fixture 1910. The laser beam 1922 travels through a beam splitter 1927, which allows laser beam 1922 from the beam emitter 1921 to pass through to the beam expander 1990, and further allows a reflected beam 1953 from the beam expander 1990 to be provided to the vision subsystem 1952. In this embodiment, the beam expander 1990 takes the form of a focus telescope. The focus telescope includes a fixed lens 1992 and moving lens 1994 of equal but opposite power, resulting in a magnification of approximately one. With a magnification of approximately one, a divergence change in the laser beam can be made without any significant change in the beam size.

Before entering the beam-directing device, shown as including galvanometers 1924 and the scan lens 1920, the moving lens 1994 adjusts the divergence of the laser beam 1922 and the vision field at the galvos 1924 and the scan lens 1920. This change in divergence leads to a change in the effective focal length of the optics (the scan lens plus the focus telescope). This in turn results in a change in the height of the focal point at the panel 1940, thereby compensating for variations in panel thickness. Note that the beam expander 1990 could, if desired, alternatively take the form of a removable fixed lens. In such a case, the fixed lens is changed by the operator to adjust the divergence of the laser beam 1922.

As shown in FIG. 19, the moving lens 1994 moves relative to the fixed lens 1992. In one embodiment, the scan lens 1920 is of a telecentric design, resulting in the beam passed through the lens 1920 being approximately parallel to the axis of the lens 1920 (across the usable field of vision of the lens 1920), as depicted by the two sets of beam cones emerging from the galvos 1924 and scan lens 1920 combination. The moving lens 1994 is shown in positions A, B and C.

Position A results in the largest divergence of the beam 1992 entering the galvos 1924 and scan lens 1920. This in turn results in the shortest focal length (focal length A) of the beam 1922 downstream of the scan lens 1920, leading to the focal point A being at the highest distance within the working plane range 1995 from the panel fixture 1910. Position B is an intermediate moving lens 1994 position, which results in a beam divergence B, an intermediate focal length B and a focal point B at an intermediate distance, within the working plane range 1995 from the panel fixture 1910. With the moving lens 1994 at position C, an even less divergent beam, having beam divergence C. This in turn leads to the longest focal length C downstream of the scan lens 1920, and to focal point position C, closer to the panel fixture 1910 and thus better suited for thin panels.

Note that, as well as adjusting the focal point location of the laser beam 1922 at the surface of the panel 1940, the focus telescope 1990 also adjusts the effective focal plane of the vision subsystem 1952 due to its position downstream of the beam splitter 1927 and within the collinear portion of the path of the laser beam and reflected light directed via the galvos 1924 and scan lens 1920. Thus, the vision subsystem maintains a clear focus on the surface of the panel 1940, irrespective of the thickness of the panel.

Further note that the same effect as that obtained with the telescope can also be achieved using other beam modifying means. One example is the use of a transmissive or reflective adaptive optic that may be placed in the beam path at the same location as the telescope 1900. By changing the focal length of the adaptive optics, the beam divergence and vision system focus can be altered as previously described. In the case of transmissive optical elements, it is further desirable that the optics of the beam modifying device be highly transmissive at both the laser beam and vision system wavelengths. This can be achieved through the use of special anti-reflection coatings that provide maximum transmission at the laser and vision illumination wavelengths.

Since the focus of the vision system is maintained at the same plane as the laser beam focus using the technique described above, it is possible to determine the focus of the beam and vision subsystems using the image from the vision system alone. Thus, the telescope 1990 (or other corresponding beam adjusting means) could be adjusted once a panel is fixed to the panel fixture 1910, and images from the vision system 1952 processed by the image processing electronics and/or system controller to determine the best movable lens 1994 position based on the best image focus at the panel surface. Once the optimal telescope position is thus determined, the laser beam will necessarily also be focused at the panel surface.

In cases where the panel thickness varies across a single panel, it may be necessary to adjust the focus of the beam and vision subsystems during processing of the panel. This may be accomplished by first mapping the panel thickness profile within the XY plane using the vision subsystem as previously described, or other height sensing means, and then dynamically adjusting the telescope or other corresponding device to maintain this focus based on the profile data and the XY position of the panel fixture under the field of view of the scan lens 1920.

Tip Cleaning

During the trimming process it may be desirable to remove contaminants from the probe tips and/or condition the probe tips. It is common for debris and/or vapor to be emitted from the material being trimmed. Additionally, the panel probe pads themselves may have a coating or dust that is picked up by the probe tips during probing. Over time this material may form a deposit on the probe tips that compromises the electrical probe tip contact with pads on the panel. Furthermore, the probe tip morphology may change through extended use.

To extend the useful life of the probe card and probe tips, a probe scrub pad 1055 is included as part of the calibration subassembly 1035, as shown in FIG. 10a. The scrub pad 1055 may be, for example, a flat plate or sheet of abrasive material, such as silicon carbide (SiC) or any other material capable of cleaning the probe tip material without damaging the probe tip. The scrub pad 1055 may also, or alternatively, be composed of one or more cleaning materials that aid or effect the removal of debris and contaminants from the probe tips. In one embodiment, the scrub pad 1055 has a size equal to or exceeding the probe card tip field.

The system controller (e.g., controller 550 of FIG. 9a) commands the X and Y stages (e.g., X-Y stage 542 of FIG. 9a) to position the scrub pad 1055 under the probe field, and commands the Z stage (e.g., Z-Theta stage 560 of FIG. 9a) to move downward until the probes make contact with the scrub pad 1055. At this point, a cycle is started that in one embodiment involves some combination of up and down Z axis motion and X and Y axis dither, in order to remove debris and contaminants from the probe tips. The cycle may be extended to further condition the tips in order to repair defects caused by surface morphology resulting from use.

Power Measurement Calibration

Control of the laser power during lasing is critical to achieve quality results. The power for the laser must be set prior to lasing, such as during a job setup procedure. However, the laser power may drift over time due to laser instability, optical beam path drift, or contamination of optics. Thus, the laser power can also be checked periodically during any one job session.

To measure the laser beam power as it reaches the work piece, a power meter head 1060, which in one embodiment comprises a thermopile detector and amplifier, is included as part of the calibration subassembly 1035. The system controller commands (e.g., controller 550 of FIG. 9a or a dedicated controller included in the calibration subassembly 1035) the X and Y stages (X-Y stage 542 of FIG. 9a) and the beam-directing device (e.g., beam-directing device 524 of FIG. 9a) to position the power meter head 1060 and the laser beam such that the beam is incident on the head surface (e.g., the thermopile surface). The laser is turned-on using the settings associated with a particular lasing job, and the power value is read from the meter head 1060. The reading is transmitted via a link 1065, such as and through an electrical interface, to the system controller. Thus, the power value obtained represents the actual power that will reach the target elements on the panel, with all of the drift effects accounted for.

During job setup, the power value is processed by the system controller, which then issues commands to the later subsystem to adjust the laser output power to that desired power prior to proceeding with lasing of the work piece. By adjusting the laser output power (e.g., by adjusting beam attenuators in the laser beam path between the laser and the work piece) while measuring the beam power at the power meter head 1060, the correct laser beam and/or attenuator settings may be established for the job. This calibration of laser power may be performed automatically by the system controller at the beginning of each lasing session (e.g., one calibration each time a new set of lasing parameters is loaded).

Additionally, the laser beam power may be monitored during lasing operations (i.e., during a job) to ensure that the laser beam power remains within tolerance of the desired value. This may also be done automatically and in real-time by the system controller during the lasing of any one element of a panel, or between trimming sites on a single panel, or between panels, or between panel batches, or at appropriate selected time intervals based on appropriate environmental and machine stability criteria for the particular application.

X-Y Stage Calibration

Without the use of a sacrificial plate or special grid as done in conventional systems, the laser beam scan field and the vision scan field can be calibrated using the known position of the XY stages (e.g., X-Y stages 542 of FIG. 9a).

In more detail, recall that the XY stages can be built on precisely machined bearing rails such that their motion is highly linear and orthogonal. However, due to inevitable mechanical tolerance build-up and other non-linearity in the position encoders, the motion is not perfect. Thus, errors in the XY stage motion are compensated by applying an error correction look-up table or error correction algorithm. The stage controller (X-Y stage controller 544 of FIG. 9a) or the system controller (e.g., controller 550 of FIG. 9a) utilizes the table or algorithm, in conjunction with conventional interpolation and/or extrapolation techniques, to correct linearity, scale, orthogonality, straightness, and other distortions.

More particularly and a shown in FIG. 10b, a glass plate 1075 with a reference 1080 (which could take the form of a grid or markings) having a size substantially that of the XY stage travel, is placed on the panel fixture 1030. The reference 1080 could be, for example, chrome or some other material. The system controller commands movement of the XY stages and imaging by vision subsystem (vision subsystem 552 of FIG. 9a) so as to acquire images of the reference 1080. The acquired image data is processed by the system controller to determine a position error in the X-Y system coordinates at each of an array of points across the plate 1075. The errors thus determined are used to populate the look-up table or as input to the correction algorithm described above, and thereby calibrate the XY stages in the system coordinates. The correction values stored in the table or algorithm are applied by the system and/or motion controller during further operations to correctly command movement of the XY stages. The XY stages are thereby calibrated, and may now be used as a reference for XY position within the system. Note that this calibration can typically be performed infrequently. The frequency will depend upon various external environment conditions which could affect the motion of the XY stages for the particular application, as will be understood in light of this disclosure.

Laser and Vision Subsystem Calibration (Galvo Calibration)

As previously discussed in reference to FIG. 9a, the lasing system 500 incorporates a vision subsystem 552 that is capable of viewing, through the laser subsystem 530 optics, the entire field of view of lens 520. The laser and vision subsystems can be calibrated with reference to the coordinate system (which in one embodiment is associated with the panel fixture) as well as any offsets that may exist between the vision subsystem 552 and the laser subsystem 530 due to non-coaxial alignment. The galvo calibration aperture 1020 in conjunction with the detector 1025 can be used to calibrate the laser and vision subsystems, as will now be explained.

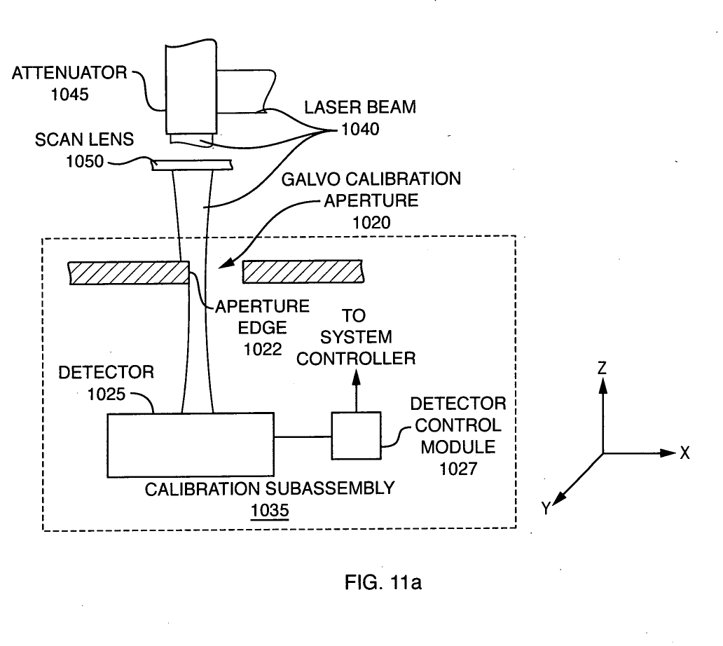

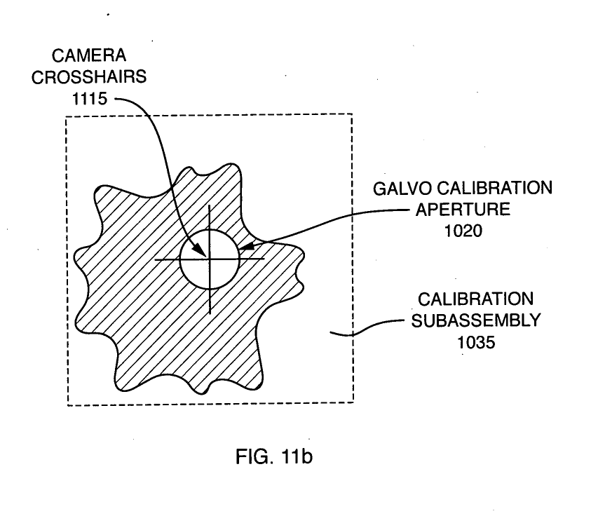

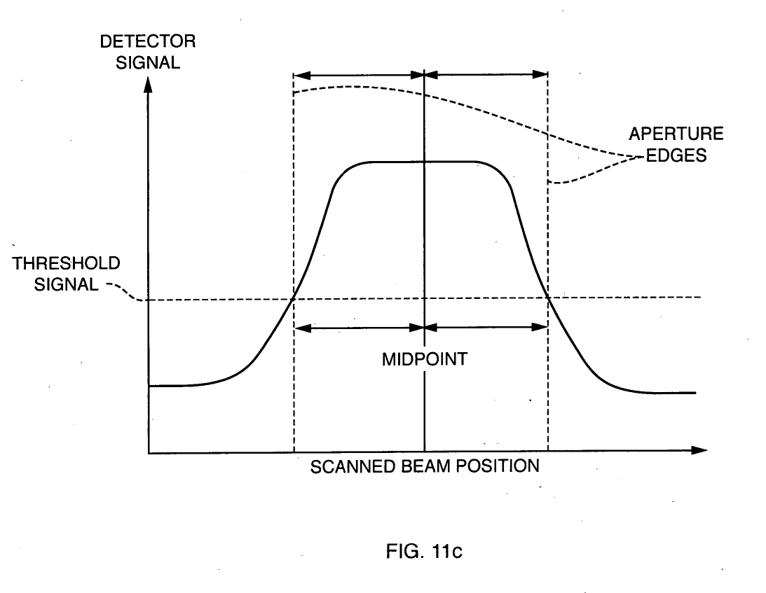

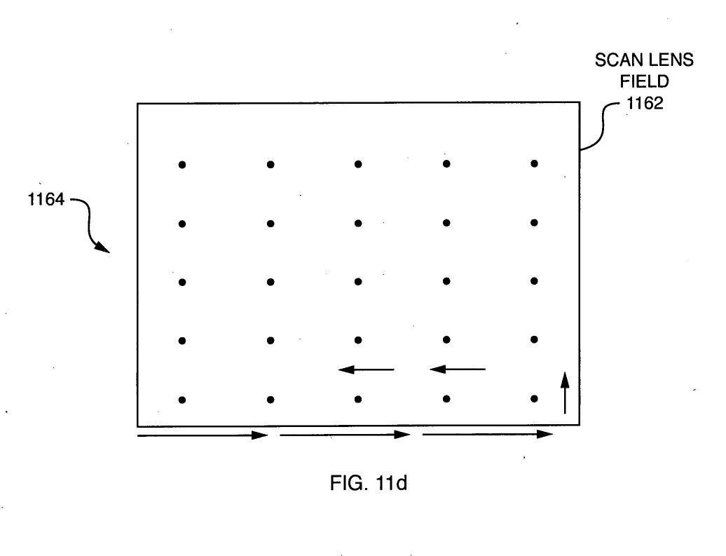

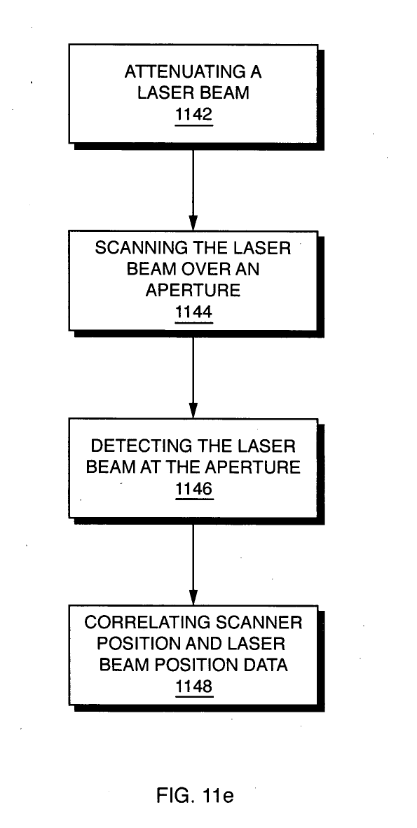

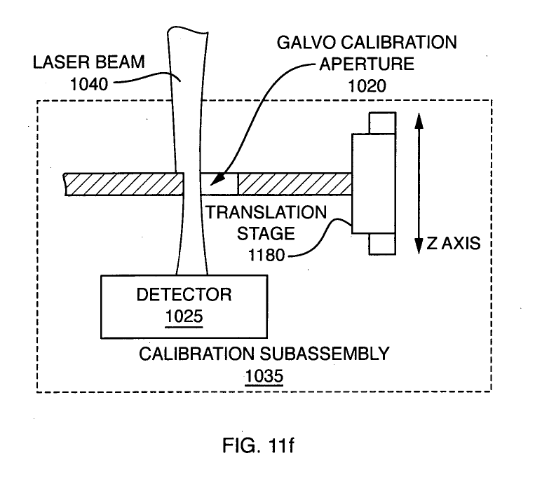

Referring to FIGS. 11a and 11b, an enlarged view of the calibration aperture 1020 and detector 1025 configured in accordance with an embodiment of the present invention is illustrated. To calibrate the laser and vision subsystems, such as laser and vision subsystems 530 and 552 of FIG. 9a, the detector 1025 detects the position of the moveable focused laser beam 1040, which could serve as laser beam 522 of FIG. 9a, relative to the known position of the aperture 1020. Thus, with the aperture 1020 placed over the detector 1025, a laser beam is scanned over the aperture 1020 while the detector 1025 provides corresponding output signals. A similar calibration procedure is described in U.S. Pat. No. 6,501,061, which is herein incorporated in its entirety by reference.

The output signals from the detector 1025 are processed by the detector control module 1027. By processing the detector output signals, the detector control module 1027 determines a profile of the detector output signals versus scanner position. By recording a scan position coincident with the edge 1022 of the calibration aperture 1020 that corresponds to a user-defined threshold level of the detector 1025, the scan position that corresponds to a center of the aperture 1020 can be determined as being midway between scan positions where a threshold level is detected.

For example, using a first scan of the laser beam 1040 across the aperture 1020, the scan position that corresponds to the X-axis center position of the aperture 1020 can be computed by (X-position-left threshold+X-position-right threshold)/2. Hence, the x-scanner coordinates to precisely place the beam 1040 at this center position can be computed. A graphical representation of a one embodiment of this procedure is shown in FIG. 11c. Other formulas/techniques can be used to calculate the X-center to compensate for non-uniformities in the shape of the beam 1040 or to improve signal to noise ratio, as will be apparent in light of this disclosure.

A second scan of the laser beam 1040 across the aperture 1020 is made in a perpendicular direction to the first scan to determine the scan position that corresponds to the Y-center of the aperture 1020. From the second scan of the laser beam 1040, the y-scanner coordinates to precisely place the beam 1040 at the center of the aperture 1020 are calculated. By setting coordinates for the galvos (or other beam-directing device 524) at these calculated coordinates, the laser beam 1040 can be placed at the same position that the center of aperture 1020 was in during the calibration scanning.

An alternative method for finding the center of the aperture 1020 is to scan the beam 1040 across the aperture 1020 to locate multiple points on the periphery of the aperture. The scanner X, Y coordinates are recorded for each of the multiple points at the circumference of the aperture 1020, or along the perimeter of the aperture 1020 if the aperture 1020 is not circular. With a sufficient number of known data points on the periphery of the aperture combined with knowledge as to the shape of the aperture 1020, the center of the aperture 1020 can then be calculated or otherwise predicted with a high degree of accuracy.

In one embodiment of the present invention, two galvanometer mirrors are used to scan the laser beam 1040. In this case, the scanner coordinates correspond to the angle of the two galvanometer mirrors in the galvos. However, note that any type of beam-directing device and beam scanning techniques, including polygon or acousto-optic techniques, can be used to direct a laser beam through the calibration aperture 1020.

After locating the scan position that corresponds to the center of the aperture 1020, the aperture 1020 is moved to a different location within an operating field of the scan lens 1050, which could serve as scan lens 520 of FIG. 9a. In one embodiment, the aperture 1020 is moved by, for example, using a precision motion X-Y stage as previously described, with a resolution on the order of 1 μm per step. At each aperture position, the aperture center is located in the manner described above, and the galvanometer position that corresponds to that location is determined.

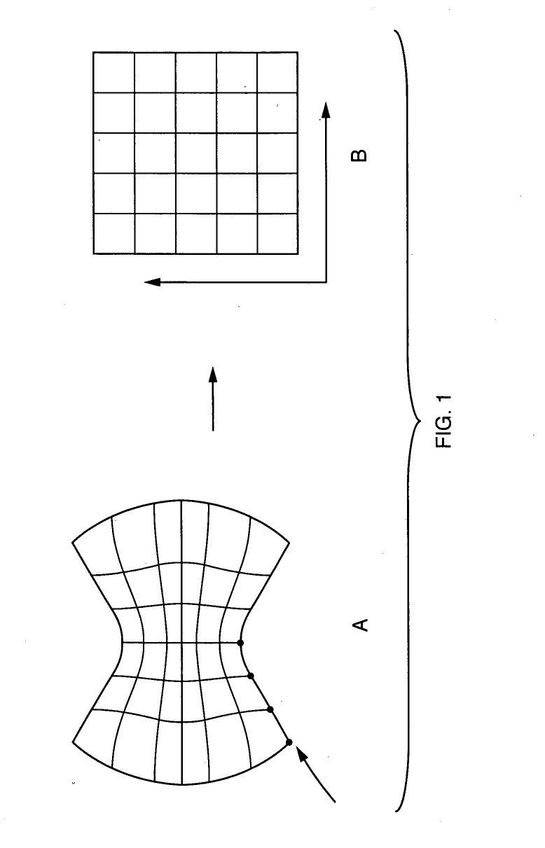

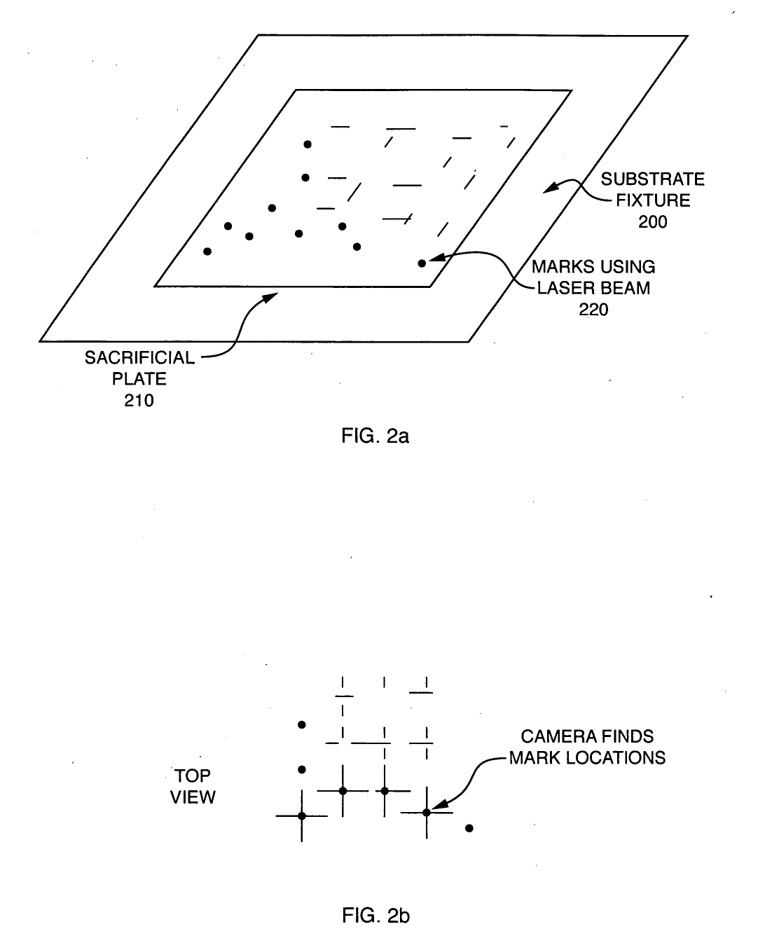

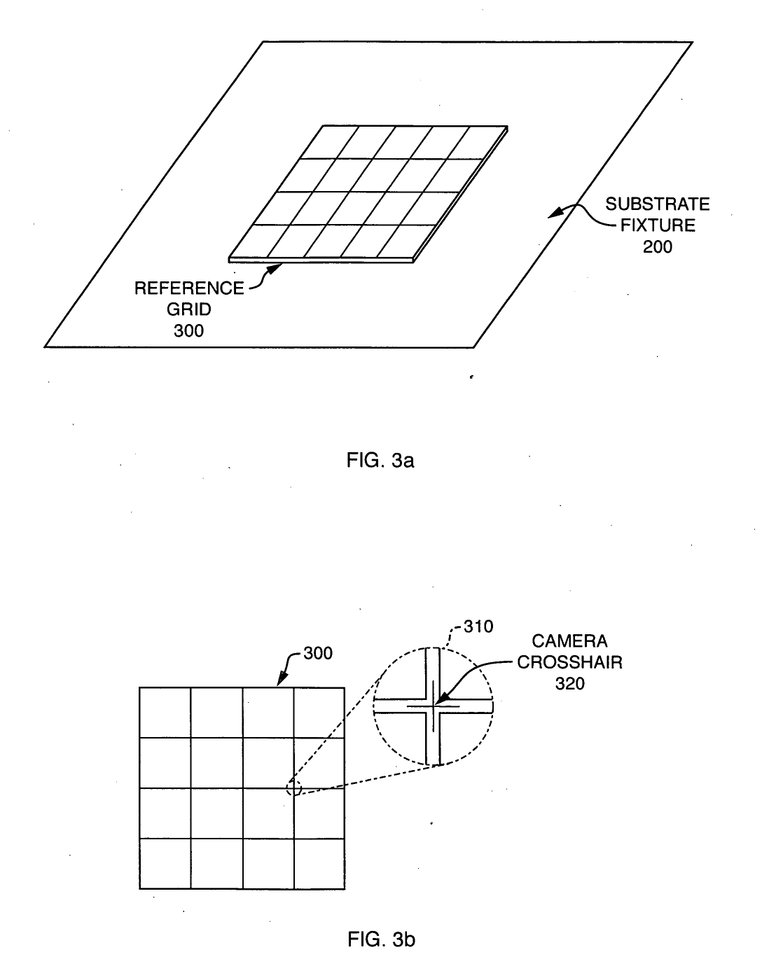

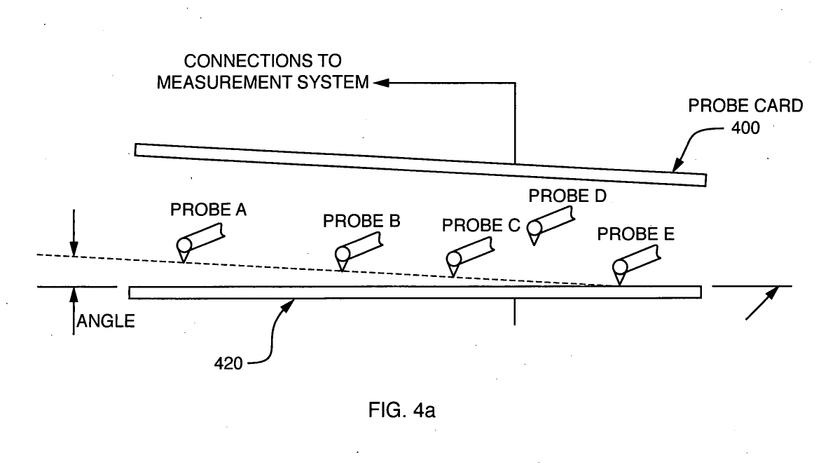

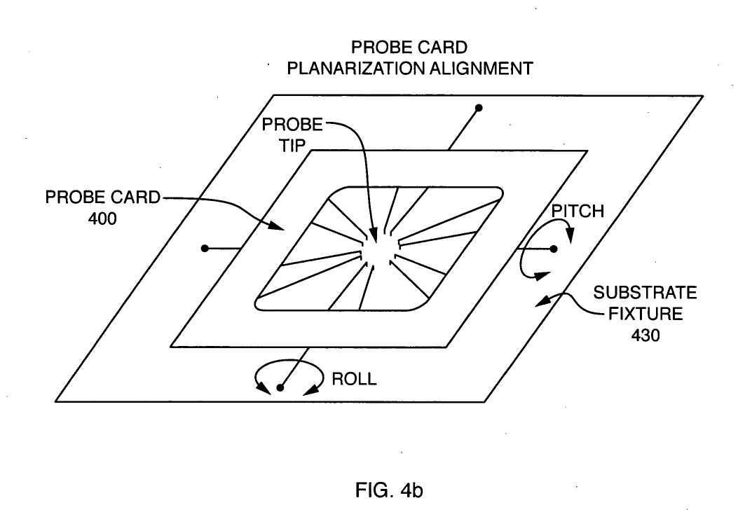

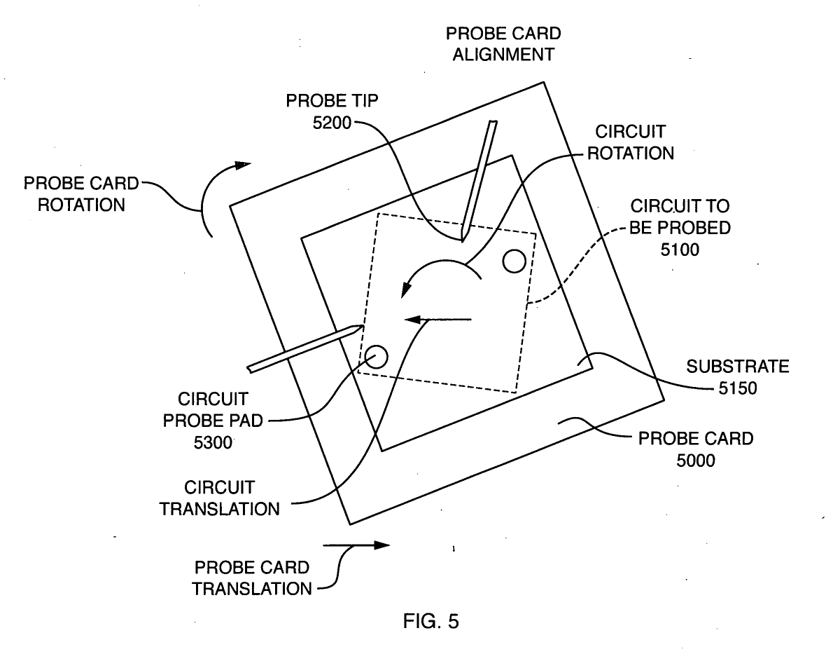

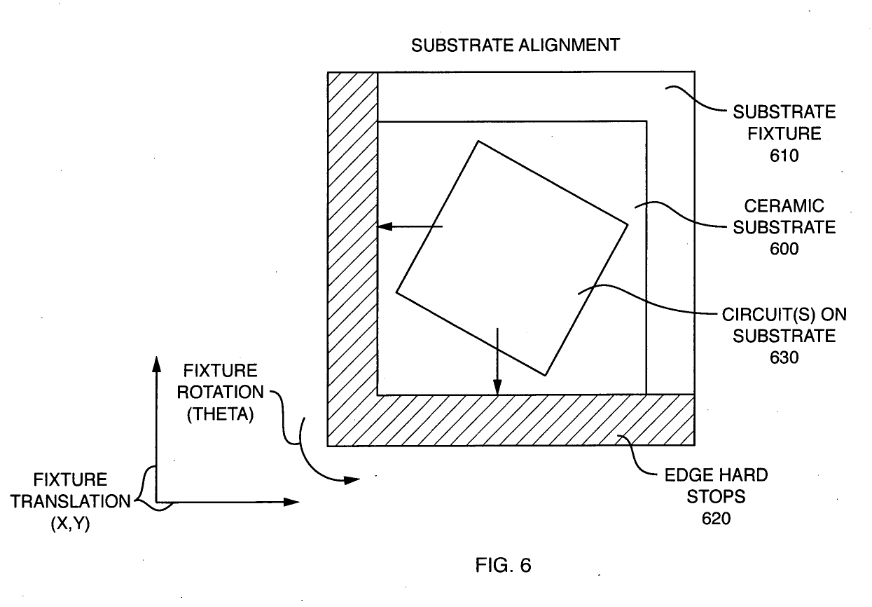

Through a series of cycles, the scanner coordinates that correspond to the grid 1164 of aperture position, as shown in FIG. 1d, are determined. From the grid 1164, the scanner coordinates for any point within the scan lens 1150 field 1162 can be computed using conventional interpolation or extrapolation techniques. The resolution and accuracy of the technique is only limited by the resolution of the scanning mechanism and the aperture positioning equipment.

Referring now to FIGS. 11a and 11e, an attenuator 1045, which could serve as attenuator 523 of FIG. 9a, can be used to reduce the intensity, without deviation, of the laser beam 1040, which as noted above could serve as beam 522 of FIG. 9a. In one embodiment, the attenuator 1045 includes a partially transmitting optic, or a series of partially transmitting optics, through which the beam is directed prior to passing through the scan lens 1050. To be effective, the partially transmitting optics must not deviate the angle or position of the transmitted beam 1040.

Alternatively, the laser power can be reduced to a sufficiently low level to avoid damaging the target aperture upstream of the scan lens. However, this may not be possible if the laser has a restricted dynamic operating range. In another alternative embodiment, the detector 1025 may include multiple detectors, or a detector array, which detect the laser beam 1040.

The system controller 550 of FIG. 9a can direct the operation of the laser system 500, as previously described, to accurately and automatically calibrate the position of the laser beam in X-Y fields using the output of the detector control module 1027. The system 500 can be directed by controller 550 to automatically test the calibration of the beam to determine if calibration is required and, if so, perform calibration as necessary in real-time. If desired, the controller 550 can direct the performance of calibration at predetermined intervals. Additionally, an operator may request calibration or testing via the operator input device 559 of FIG. 9a.

The detector 1025 locates the laser beam as it is scanned in the X-Y field 1162. The scan field could, for example, be a field of 2 by 2 inches or 4 by 4 inches. The field 1162 is formed on a plane at the surface of the panel 1005 on which the target elements are disposed. A different field 1162 is formed for each different scan lens. In one embodiment, the detector 1025 is mounted to the calibration subassembly 1035 and is moved along with the panel fixture 1030 using the X and Y stage, such as stages 920 925 of FIG. 9b, and provides accurate position information through feedback to the control module 1027 whenever the laser beam 1040 is sensed.

In one operational embodiment, the aperture 1020 is as shown in FIG. 11a, positioned above the detector 1025. The diameter of the aperture 1020 may be larger or smaller then the diameter of the laser beam 1040. As previously described, the edges of the aperture 1020 can be detected as the laser beam is scanned in the field 1162. Note, however, the detector 1025 alone could be used to detect a maximum laser beam signal or some other signal characteristic to indicate the beam location. For example, the detector 1025 edges could be used in place of the aperture edges to compute a center of detection position, or a maximum signal from the detector 1025 could be used directly to indicate the beam location. In any event, the scan lens 1050 is moved parallel to the Z axis to position and focus of the laser beam 1040 at or near the surface of the aperture 1020. The calibration process begins by the system controller directing the X and Y stage to position the calibration aperture 1020 combination in the field 1162 to be calibrated.

The system controller 550 or control module 1027 then activates the laser and commands the beam-directing device to scan the laser beam 1040 in the field 1162. When the laser beam 1040 is sensed by the detector 1025, the control module 1027 executes a search algorithm to identify the edges of the aperture 1020. After each edge is located, the control module 1027 either: 1) records the commanded beam-directing device position and the stage positions and processes this information to calculate scanner coordinates for that location in the field 1162; or 2) transmits the identified edge locations to the system controller 550 which performs the recording and processing. The system controller 550 or control module 1027 then moves the X and Y stage to another location in the field 1162 and repeats the process to find the aperture edges.

Techniques used to determine the location of the edges of the aperture may beneficially include a binary search for the beam position, while the laser beam is alternated between corresponding above and below threshold signal positions with decreasing step size until a minimum tolerance is determined. Alternatively, the beam may be scanned over the edge and a maximum of the first and/or a zero of the second derivative of the signal may be used to calculate the edge position from the scan data. Here, the influence of noise on the detector signal, which can affect the edge sensing accuracy, is reduced.

This process is repeated at multiple locations. For example, 25 locations in a 2 by 2 square inch or 4 by 4 square inch area may be required to create an accurate mapping of the field 1162 in scanner coordinates. The system controller 550 or control module 1027 executes a control algorithm that includes at least a first order polynomial to process the position information to interpolate a coordinate map of the field 1162. The coordinate map can then be used to correct field distortions by extrapolating new command positions for the beam-directing device, which correspond to the targeted positions, from the scanner coordinates associated with the measured positions.

FIG. 11e is a flowchart of method for calibrating the laser such that a correlation between the position of the laser beam 1040 and the position of the laser beam-directing device 524 is established. The laser beam 1040 is attenuated 1142 to reduce the energy density and thereby avoid damaging the detector 1025. The laser beam 1040 is scanned 1144 over the calibration aperture 1020. The scanned beam is detected 1146 by detector 1025. The position of the laser beam 1040 is correlated 1148 with the position of the laser beam-directing device based on the detected laser beam characteristics. This correlation data is used to determine the center of the aperture 1020 on the work surface and/or the scanner position coordinates that correspond with a desired position of the laser beam 1040.

The use of different types of detectors allows lasers with different laser wavelengths, such as IR, UV, and visible, to be calibrated. Being able to calibrate different laser wavelengths, allows the system to process different types of materials.

The vision subsystem 552 is able to view through the optics of the beam-directing optics, e.g. via the galvanometers, and to view the entire field of the scan lens. The vision subsystem also must be calibrated with reference to the system coordinates, as well as any offsets that may be present between the vision subsystem and the laser subsystem due to non-coaxial alignment of the system. A similar technique to that described above for the laser beam calibration may be used to calibrate the vision subsystem.

As shown in FIG. 11b, the calibration aperture 1020 is positioned under a first point in the field, the point is centered on the camera crosshairs 1115 (which indicate the center of the image detected by the camera) using the beam-directing device 524 and automatic pattern recognition functionality in the vision subsystem 552, pursuant to commands from the system controller 550. The X and Y galvo positions (of beam-directing device 524) corresponding to the center of the calibration aperture 1020 are thus determined for the vision subsystem 552. This process is repeated for an array of points across the scan field. The resolution and accuracy of the determinations are only limited by the resolution of the beam-directing device 524 and the vision subsystem 552. It should be noted that, although the target in this case is the calibration aperture 1020, another module on the calibration subassembly or on a PCB panel mounted on the panel fixture could alternatively be used for this calibration.

The system controller 550 executes a control algorithm that includes at least a first order polynomial to process the collected position information in order to interpolate a coordinate map of the field. The coordinate map can then be used by the system controller 550 to correct field distortions by extrapolating calibrated positions corresponding to the targeted positions in the system coordinates based on the coordinate mapping. The extrapolated calibrated positions are used in commanding the beam-directing device 524.

It should be noted that the laser subsystem 530 and vision subsystem 552 calibration may be performed separately or simultaneously to save time. Once the calibration aperture is located by the XY stages 542 at any of the grid locations previously described, the calibration of both the vision and laser beam subsystems can performed before moving the aperture to the next location.

It may further be advantageous to use the calibration techniques described herein but with a pattern of XY locations that does not form a regular grid or array of points. For example, it may be desirable to include a higher density or number of points near the edges of the scan lens 520 field since distortions are typically larger in this region, and a lower density or number of points in the middle of the field, thereby saving time during calibration.

It should also be noted that the destination number of points calibrated, and also the degree of the interpolating polynomials, is chosen to achieve the required accuracy of correction. In the case of a system including galvos, the required accuracy is typically better than few microns for a given scan lens f-theta distortion or linearity error of beam position with respect to galvo angle. Both flat field focus and good f-theta linearity across the scan field can be achieved, but typically require a complex lens design, often with multiple elements and/or exotic materials.

Thus, the above described calibration can reduce the cost and complexity of the scan lens 520 by compensating for the distortion in the design to the required degree for the particular application.

A variation in the calibration technique is to set the calibration points proximate to the locations in the scan lens 520 field that correspond to the target locations on the panel. In this manner, little or no interpolation of the transformed XY beam or vision subsystem position coordinates is needed. By avoiding the need for interpolation, and in the case where few elements are to be lased in the field, the time required during calibration could thereby be reduced.

Using the same calibration aperture 1020 provides a simple and accurate means for calibrating both the laser beam and vision system by, for example, correcting the galvo positions for beam and image positioning. The automated techniques described herein accurately and automatically calibrate the position of the laser beam and vision subsystems in the XY system coordinates. The technique can be configured to automatically determine if calibration is required, and to perform any necessary calibration. If desired, the determination and calibration can be automatically performed at predetermined intervals, or initiated at the operators request which is entered to the via an operator input device.

Focus Adjustment Calibration

Referring again to FIGS. 11f and 19, the focus of the laser beam and the camera imaging may be changed to accommodate different panel thicknesses. As a result, the divergence of the laser beam will change, and the scan lens field will be slightly distorted. Thus, without correction, the beam and image calibrated at one focal plane, or panel thickness, will have errors at another focal plane.

To address this problem, the calibration aperture 1020 of a calibration subassembly 1035 is moved in the Z axis direction to facilitate calibration of the beam and/or vision subsystem for different focal planes. The calibration aperture 1020 is mounted on a translation stage 1180 controlled by the system controller 550.

In one particular embodiment, the system controller 550 commands both the translation stage 1180 shown in FIG. 11f, and the focus telescope 1990 as described with reference to FIG. 19, such that the beam focus and the aperture are coincident with the panel fixture 1910 surface, corresponding to zero panel thickness. The system controller 550 then issues commands, thereby initiating calibration of beam and vision subsystems as described herein. Next, the system controller 550 commands both the translation stage and the focus telescope such that the beam focus and the aperture are at a thicker panel thickness, typically 1 to 4 mm, which could, for example, correspond to focal point A, B or C of FIG. 19. Finally, the system controller 550 issues commands to initiate calibration of the vision subsystem only.

Due to the laser beam and imaging being substantially coaxial and having respective paths passing through the same focus telescope 1990 optics, modification to the scan field shape resulting from a focus change is nearly identical for both the laser beam and the vision image. Thus, only one calibration needs to be performed, and the beam calibration at the upper focus position can be easily computed from the vision calibration data.

Since the relationship between the focus telescope 1990 setting and the scan field distortion is close to linear, the beam-directing device 524 (e.g. the galvo) calibration at any other focal plane can be interpolated or extrapolated using conventional techniques based on calibrations performed at the two focal planes. Note that the techniques described herein can be implemented with some variations. For example, the calibration may be performed for the actual panel thickness being trimmed such that interpolation is not required, if the panel thickness is relatively constant. Furthermore, other combinations that use the beam and vision calibration techniques described herein may be used for setup and testing.

In summary, the above described calibration provides a laser system, such as the system depicted in FIG. 9a, with numerous advantages. For example, the system is able to operate periodically and automatically without operator intervention. Time is saved because an operator is not required to install calibration apparatus. The calibration consistency and repeatability is improved because the process is automated and can be performed real-time. Calibration data can be collected and logged for statistical investigation. Calibration data can be applied to other processes, such as for scheduling maintenance. The overall cost of trimming circuit elements on panels is reduced because the calibration speed is increased. There are fewer panels rejected because of increased consistency and no consumables (e.g., test panels used for calibration).

Probe Card Planarization Calibration

In order to ensure that each of the probes will make sufficient contact with the probe pads of a circuit for measuring an electrical characteristic of a circuit element, probe card planarization can be performed.

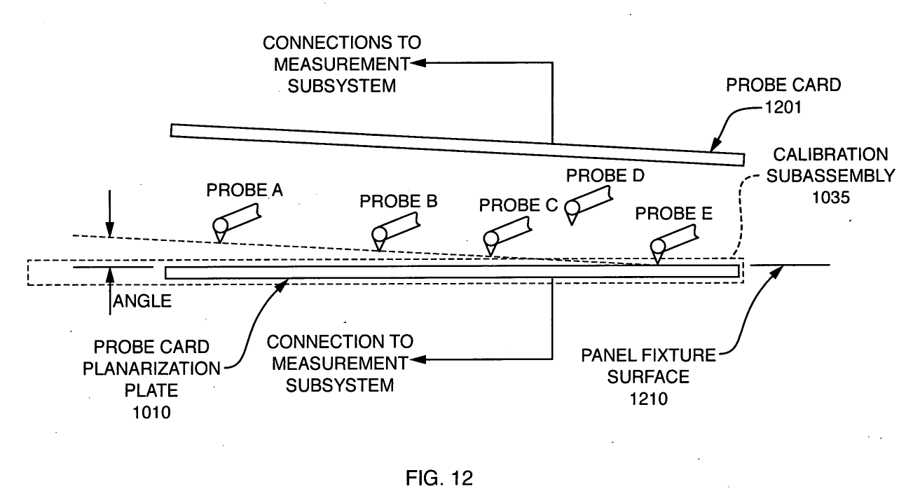

Referring to FIG. 12, laser trimming systems typically use a consumable probe card 1201 containing test probes A-E to contact measurement points on a circuit before, during and/or after trimming. For accurate measurement-based trimming, the probe tip must electrically connect to measurement system, and uniform probe tip Z axis positioning relative to the circuit board (generally referred to as planarity) must be maintained. In addition, note that probe tip over-travel after contact will affect contact quality due to scrubbing, as will also affect probe life due to contact/scrub force and bending of the probe tip. Probes installed in a trimming system can be periodically tested so that probe life can be monitored and probing errors due, for example, to contact failure minimized.

To calibrate the probe for planarity, a flat conducting test plate such as probe card planarization plate 1010, which in one embodiment is located at the panel fixture surface 1210, is connected to the probe measurement subsystem. In one particular operational sequence, the X and Y stages 542 move the fixture, and therefore the test plate 1010 under probe card 1201, which is typically supported by a probe holder as previously described. The probe measurement subsystem sets-up to measure resistance of selected probes A-E relative to the test plate. The Z stage moves down in small steps until first probe tip makes contact (e.g., the tip of probe ‘E’ in FIG. 12). The Z position is stored in memory for probe ‘E’. The Z stage (e.g., 945 or 9210A/B) moves down until next probe tip makes contact, with this movement limit to a maximum travel distance past the Z position at which the first probe tip contact was made to avoid damage to probe. The Z position is stored for this second probe (e.g., probe “C” of FIG. 12). Z stage movement and Z position storage are repeated until all probe tips of the selected probes are in contact with the work piece.

Utilizing the saved Z position information, it is now possible to construct a Z map of the probe card. It can be determined if any probe tip contacts are missing (e.g., probe D in FIG. 12). Manual or automatic probe card roll and pitch adjustments can be performed at this point to achieve optimum probe card planarization to the plate 1010. The above sequence can be repeated iteratively if necessary and with intermediate adjustments to probe card 1201 roll and/or pitch to prevent excessive probe over-travel during the procedure.

Alternatively or additionally, probe tip planarization can be obtained by trimming the tips within the system by cutting, milling, grinding, or polishing the individual probe tips or all the tips simultaneously, so as to be parallel to the plate 1010. Testing may be performed before and/or after such tip trimming as per the procedure above.

Contact resistance testing after planarization gives verification of probe and electrical connection conditions. The point of contact, or Z contact position, can be determined after planarization, and the appropriate final Z position of the probe card to provide the correct over-travel for best probe contact and life can be computed using conventional techniques.

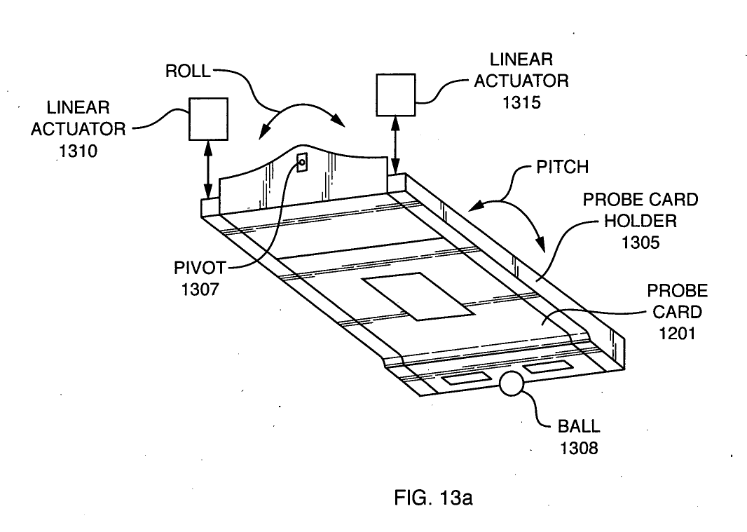

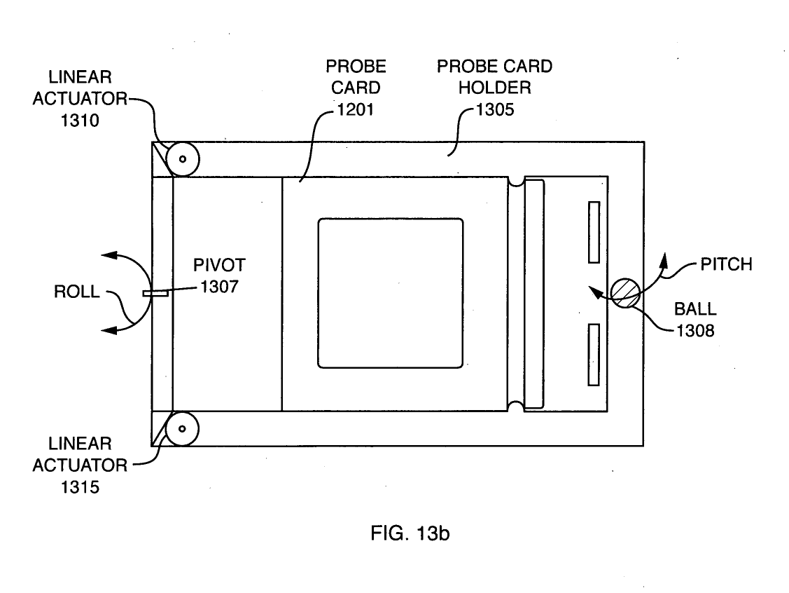

An embodiment of a probe planarization subassembly is shown in FIGS. 13a and 13b. The probe card 1201 is mounted in probe card holder 1305. This, in turn, is mounted on the Z and theta stages that may be of the type previously described (e.g., 945 or 9210A/B of FIGS. 9b and 9e). The planarization of the probe card 1201 is effected by means of two linear actuators, 1310 and 1315, shown in FIGS. 13a and 13b, that provide vertical motion at one end of the probe card holder 1305. A sliding pivot 1307 and ball 1308 allow the probe card holder 1305 to be rotated in two directions (i.e. pitched and rolled about the pitch and roll axes) to provide planarization of the probe card 1201 to the panel fixture surface 1210.

The pivot 1307 and ball 1308 provide rotatable support for the probe card holder 1305 that, when combined with the linear actuators 1310 and 1315, provide highly accurate roll and pitch adjustment of the probe card holder 1305 and the supported probe card 1301, to obtain the desired contact between the probe tips and the probe pads on the circuit. For example, roll adjustment may be accomplished by controlling linear actuators 1310 and 1315 to apply equal forces in opposite directions, while pitch may be accomplished by controlling linear actuators 1310 and 1315 to apply equal forces in the same direction.

In operation, after a probe card 1201 is inserted into the probe card holder 1305, the planarization commences. A flat conducting plate referred to as the probe card planarization plate 1010, is included as part of the calibration subassembly 1035. The probe card planarization plate 1010 is connected to the measurement subsystem that is also connected to the probes on the probe card 1201. Through an iterative process, the probe card 1201 is brought into contact with the probe card planarization plate 1010, and adjustments are made to the roll and pitch using linear actuators 1310 and 1315, as shown in FIGS. 13a and 13b, thereby causing the probe tips to make contact with the probe card planarization plate 1010. In one embodiment, this is an automated operation, with the control of the Z stage, actuators and the required calculations and determinations performed by the system controller 550 or a dedicated controller included in the calibration subassembly 1035.

The technique previously described may also be used to measure the probe tip planarization one probe tip with respect to other probe tips of the probe card. For example with reference to FIG. 12, the offset of the tip of probe D with respect to the plane of the tips of the other probes A, B, C and E may be determined without first planarizing that plane of the probe tips to the plane of the planarization plate 1010, and hence the panel fixture surface 1210. Note that the planarization technique can be accomplished with the use of a vision subsystem connected to the system controller 550, or other sensing means to determine the tip location with respect to the system coordinates along the Z axis. In all cases, an optimum probe card roll and pitch adjustment may be determined through best fit or other well known techniques using two or more probe tips on the probe card. This optimum roll/pitch adjustment as well as the desired optimum Z probing position of the probe card may take into account the surface morphology of the panel test pads, the probe tip type and material, the desired over-travel distance, and/or other factors. Further note that the probe card holder 1305 and other structure for performing the roll and pitch adjustment previously described may be suitably provided by other means so long as at least two degrees of rotation freedom about the plane of the probe card are provided. The adjustment may be performed manually or automatically with manual or motorized height, pitch and/or roll adjustors. The technique described above may additionally or alternatively be used during automated system trimming operation to test for probe card planarization and thereby reduce probing errors due to contact failure and predict probe card life.

Probe Card Alignment Calibration

The position of the probe card 1201 probe tips in three dimensional space must be determined in order to meet the probe tip positioning accuracy requirements for correct contact with the panel contact pads. Probe cards are typically manufactured with the probe tips positioned with good accuracy relative to one another in X, Y and Z direction. The X-Y offset and theta rotation of the probe card when installed in the probe card holder must be determined in system coordinates to achieve alignment to the circuit panel contact pads, and hence to the circuit and circuit elements, under test or being lased. In one particular embodiment, this is an automated operation.

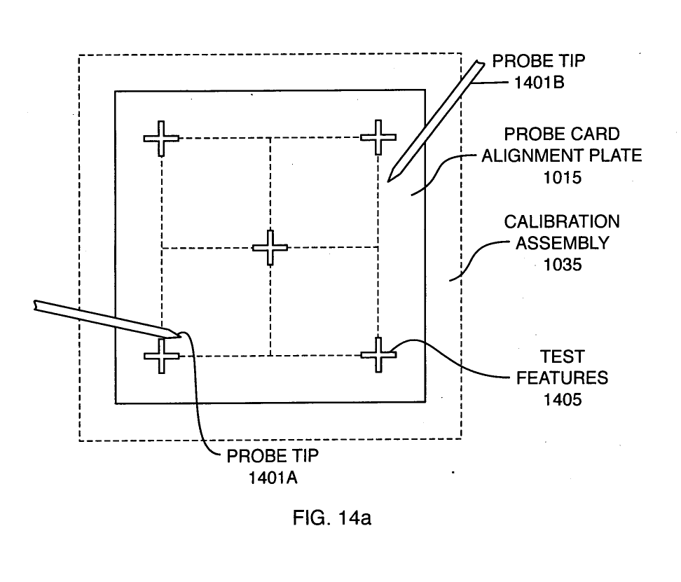

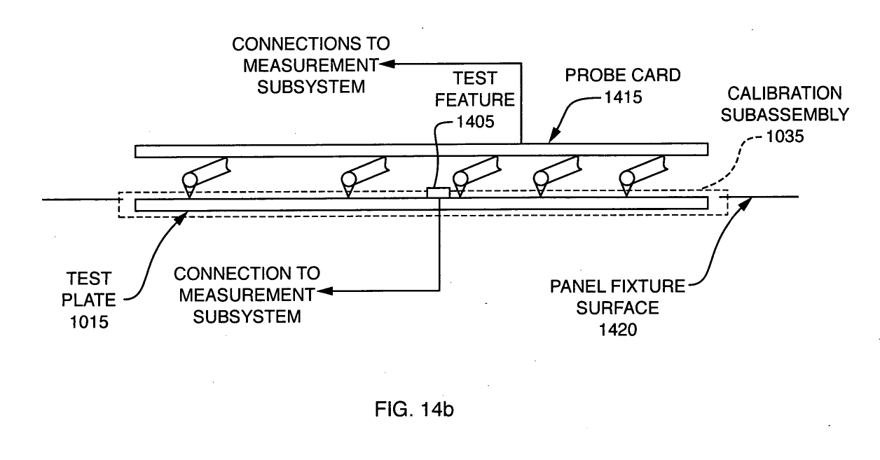

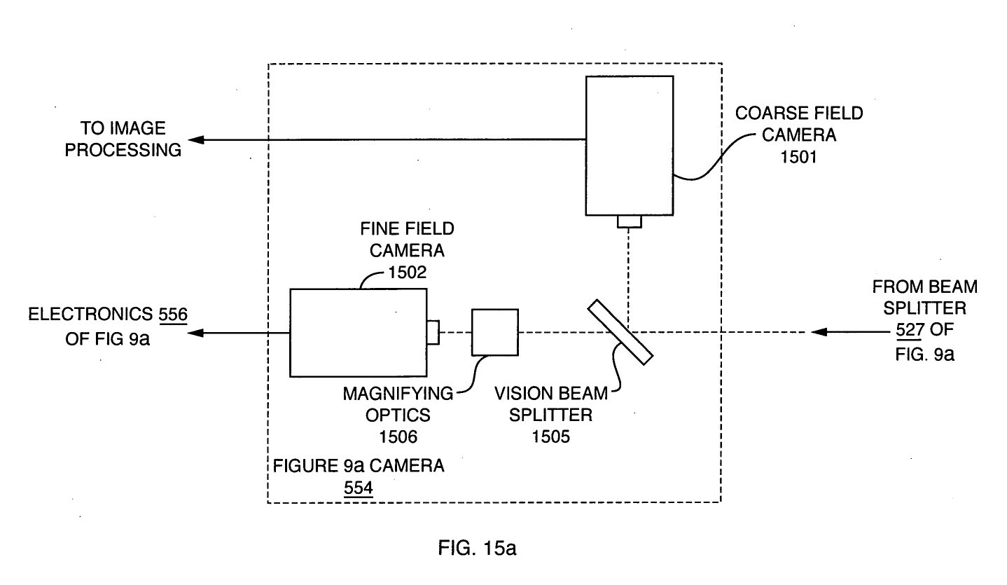

As shown in FIGS. 10a, 14a and 14b, in one embodiment, alignment is achieved by incorporating a probe card alignment plate 1015 into the calibration subassembly 1035, with conductive contact pads or other test features 1405, at a panel fixture such as a vacuum platen, surface 1420. The probe card alignment plate 1015 is connected to the measurement system. The contact test features 1045 could be a cross or box pattern as shown in FIG. 14a, or some other pattern as may be described under the circumstances. By finding the X-Y position of two probe tips 1401A and 1401B using the probe card alignment plate 1015, preferably near the diagonal extremities of the probe card 1415, the probe card 1415 X-Y offset and theta rotation offset can be determined.

The operation could, for example, proceed by first moving the X and Y stages (e.g., X-Y stage 542 of FIG. 9a) to move probe card alignment plate 1015 under probe card 1415 so that a test feature 1405 is located under a nominal position of a 1st probe tip. The measurement system sets-up to measure resistance of probe relative to test feature 1405. The Z stage moves down to contact height. The contact is checked using the measurement system. The Z moves up. The system X stage indexes by small steps along the pattern in accordance with a spiral, raster, or equivalent search algorithm. The post measurement system set-up procedure is repeated until a probe tip contacts the test feature 1405. Additional finer accuracy edge sensing algorithms may be executed for more accurate tip location determination. The X-Y stage position is recorded. The procedure is repeated for the Y axis. The overall X-Y procedure is then repeated for the other probe tip.

Based on the probe tip test feature contact, the X-Y offset and theta rotation offset of the probe card 1415 can be determined for the X-Y locations of the stage(s) corresponding to the tip locations, since the stage locations are predefined in the system coordinates. Thus, the probe card 1415 can be rotated into alignment by the theta-axis and the X-Y stage can adjust the relationship between the probe card 1415 and target circuit based on the determined X-Y offsets. The system controller uses a reverse transform of the XY tip locations or any other suitable technique, to determine rotation and XY offset values for the probe card with respect to system coordinates and uses these values to control the theta rotation angle of the Theta stage and the X-Y positioning of the X and Y stages during probing.

Automatic testing of the positions of other probe tips on the probe card 1415 can be performed to achieve optimum probe card 1415 orientation relative to a circuit through best fit or other conventional techniques. Coarse locating of the probe tips 1401A and 1401B relative to the test features 1405 may first be required so that the feature is found within reasonable time. This may be accomplished using the machine vision system (e.g., 552 of FIG. 9a), or can be done using large tip indexing XY steps with a larger box contact area surrounding the test feature to define boundaries.

The above sequence can also be automatically repeated at appropriate intervals during production trimming to ensure accurate probe tip positioning throughout a job and to determine/predict probe card failure. Additionally, two edge sensing can be performed by the vision subsystem to provide further alignment information for even a better determination of probe tip location relative to the test features 1405 on the probe card alignment plate 1015. Furthermore, a grid pattern test plate could be used to determine more than one probe tip location in parallel and thereby reduce the time required in order to calibrate the alignment of all the probe tips. Note that an actual panel circuit, rather than special probe card alignment plates 1015, could be used for alignment calibration, to determine some or all probe tip locations with respect to the actual circuit pads. In all cases, an optimum probe card theta rotation and X-Y offset may be determined through best fit or other conventional techniques.

Further note that the precise probe card alignment technique described herein could, if desired, alternatively be accomplished using a vision system connected to the system controller, or other sensing means, to determine the tip location with respect to the system coordinates along the X and Y axes. The technique may also be used to measure the probe tip XY locations with respect to other probe tips on the probe card. For example, an X-Y offset of one probe tip with respect to the locations of the tips of other probes may be determined, without first aligning the probe card in theta or X-Y direction to the system coordinates. The technique described above may additionally or alternatively be used during automated system trimming operations to test for probe card alignment, thereby reduce probing errors due to contact failure and predict probe card life. The technique may further be applied to systems incorporating moving probe subsystems, sometimes referred to as flying probes, in order to calibrate the probe tip locations in system coordinates.

Camera Configurations

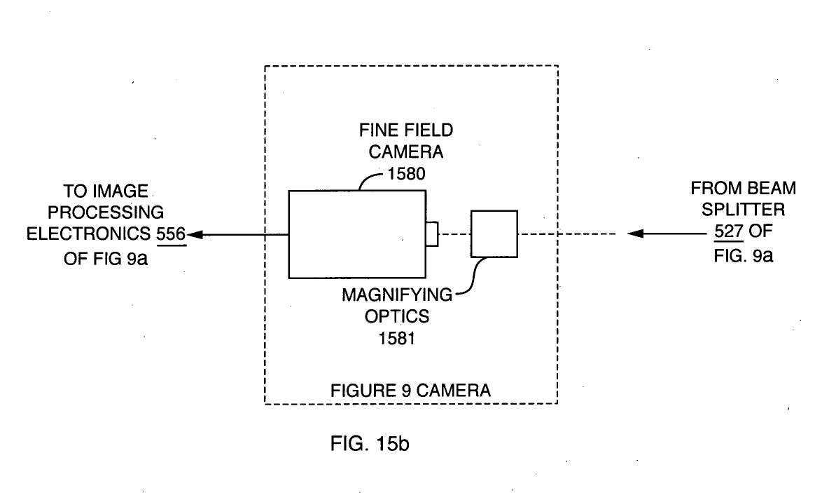

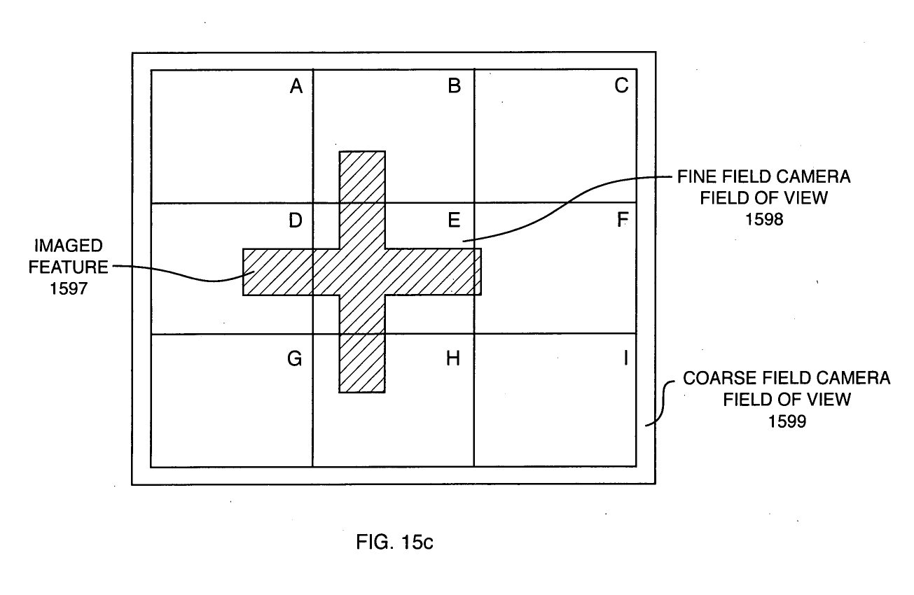

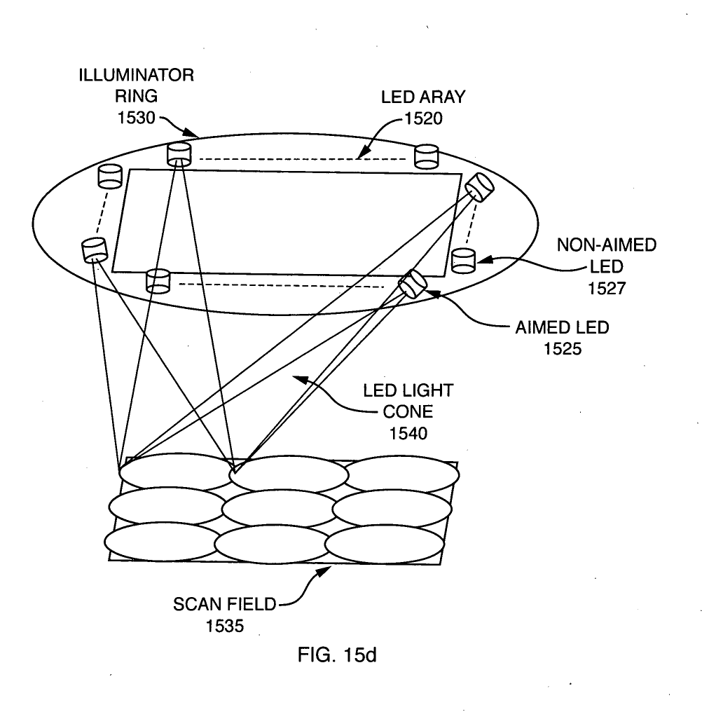

FIG. 15a shows an embodiment of the camera 554 of FIG. 9a, which includes a coarse field camera 1501 and a fine field camera 1502 with a beam splitter 1505 directing light from the work piece surface or the panel fixture surface to the cameras. Light from the beam splitter 527 of FIG. 9a is split by vision beam splitter 1505 in suitable proportion and directed to the coarse field camera 1501 and through magnifying optics 1506, which collects light from the beam splitter 1505 to the fine field camera 1502. Both cameras have optical paths that are substantially coaxial and are connected to the image processing electronics 556 of FIG. 9a. A typical field of view for the coarse field camera 1501 may be from 0.2 inches (5.08 mm) diagonal to 2 inches (50.8 mm) diagonal, while a typical field of view for the fine field camera 1502 may be from 0.001 inches (0.025 mm) diagonal to 0.2 inches (5.08 mm) diagonal.

Referring to FIG. 15c, the coarse field camera field of view 1599 can be seen encompassing and enclosing an imaged feature 1597. The feature 1597 may be imaged from a circuit board or from a calibration subassembly on the panel fixture. The coarse field camera field of view 1599 is larger than the fine field camera field of view 1598. Using the coarse field camera 1501, the image feature can be acquired fully. As shown in FIG. 15c, the fine field camera field of view 1598 may, for example, be the field labeled E and is a magnified representation of the imaged feature. The fine field camera image is a high magnification, high resolution image of a detail of the imaged feature 1597, and typically does not encompass the entire imaged feature (some of the imaged feature 1597 is also located in other fine fields B, D, F, and H).

An alternative configuration for the camera 554 of FIG. 9a is shown in FIG. 15b. Here a single fine field camera 1580 and magnifying optics 1581 collect light from the beam splitter 527 of FIG. 9a, with the resulting generated data being sent to the image processing electronics of FIG. 9a. Here, the fine field camera field of view 1598 can image areas A through I of FIG. 15c, in order to increase the virtual field of view of the camera. Areas A through I are imaged and tiled together to represent the equivalent coarse field camera field of view 1599 that is depicted in FIG. 15c. Note that the number of individual tiles could be more or less, depending on the relative requirements for magnification and field size.

The images of areas A through I can be obtained quickly and efficiently when the vision subsystem 552 incorporates through-the-lens imaging, such as in the case where the vision subsystem 552 looks through, for example, the galvos or other beam scanner 524 and the scan lens 520. The galvos or other beam scanner 524 may be commanded to move through positions for imaging areas A through I at a very high rate of speed. Images can be taken by the fine field camera 1580 through the magnifying optics 1581 of FIG. 15b, and the resulting data can be sent for each of the areas or tiles through the image processing electronics 556 shown in FIG. 9a.

The acquisition time for this example having 9 images (field of views A through I) is comparable to the acquisition time using a typical CCD camera, since movement of the galvos is extremely fast. Typical galvo move times to step from one area, such as area A, to another area such as area B is performed at a rate on the order of thirty frames per second. Note that the scanning of the field of view over the image area of interest may also or alternatively be accomplished by moving the panel using the X and/or Y stages 542 of FIG. 9a.

The tile images A through I are then merged together by the system controller 550 or image processing electronics 556 to provide a composite image corresponding to the full image of the entire feature. Note that the resolution (in pixel image size) of the composite image could be equivalent to the fine field camera resolution, or may be reduced by the image processing electronics 556 to a lower resolution than that required when unmerged tiles are displayed for fine inspection of the imaged feature, as with a single fine field camera field of view. The lowered resolution results in a reduction in the amount of data required to represent the composite image. This reduced amount of data approximates the amount of data required to represent an image of the full feature captured with a coarse field of view camera. Thus, images equivalent in those produced using a separate fine and coarse field cameras, and which can approximate an image produced using a separate coarse field camera, are obtainable using a single fine field camera. The resolution may be controlled through vision image processing electronics 556 and/or the system controller 550.

The vision subsystem 552 may also include a light source to provide illumination at the panel surface for viewing by the cameras. FIG. 15d shows an embodiment of one such illumination source. The illuminator source includes multiple arrays 1520 of light emitting diodes (LEDs). Each array 1520 includes multiple LEDs 1525 and 1527 mounted on a fixed ring 1530 as shown in FIG. 15d. The fixed ring 1530 is then mounted below the scan lens 520 of the laser subsystem 530, for example, within a fixed inner ring of a theta stage, such as the theta axis inner ring 9276 of FIG. 9e. The camera field of view may be positioned, using the galvanometers or other beam scanner within the beam-directing device 524 of the laser subsystem 530, to obtain an image at any location within the scan lens field 1535. Note that uniformity of the illumination at all areas within the scan field 1535 will enable accurate and representative vision subsystem measurement.

In the embodiment of FIG. 15d, the light cone 1540 from the LED's 1525 and 1527 are directed such that all areas of the scan field 1535 are illuminated. LEDs 1525 are aimed such that illumination is provided to the entire field 1535 from each side of the ring 1530. This multiplexed illumination minimizes the differences in the range of angles with which the light hits the panel surface and thus improves the overall illumination uniformity.

More specifically, shown in FIG. 15d are nine areas of illumination within the scan field 1535 to which each LED array respectively directs light. The use of LEDs as light sources also provides a long service life as compared to other light sources, with typical lifetimes on the order of greater than 50,000 hours. Furthermore, the narrower wavelength band of the LED as compared to an incandescent bulb, for example, reduces the chromatic distortion of the image through the optical path of the laser subsystem 530 between the panel and the camera. The illumination wavelength is chosen to optimize contrast of the features on the panel surface at the vision subsystem 552. For example, a visible, rather than infra-red, LED wavelength may be preferable in order to provide better contrast between two dielectric materials.

Panel Calibration

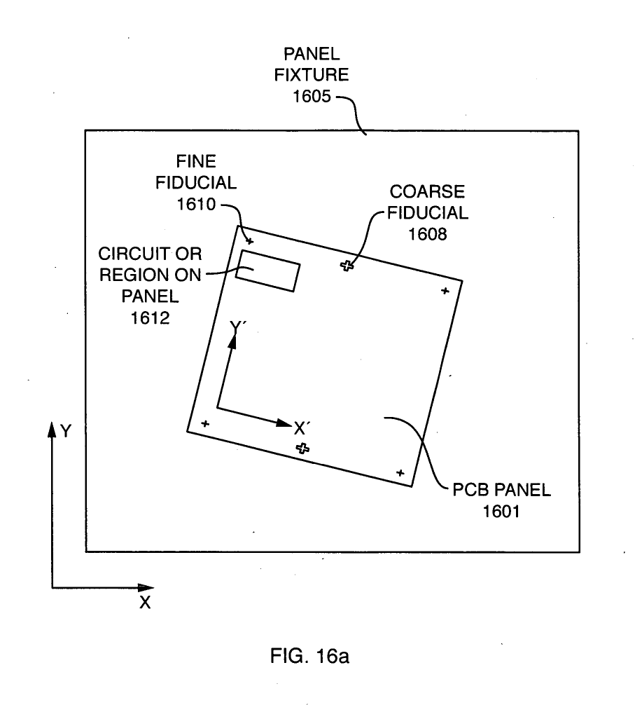

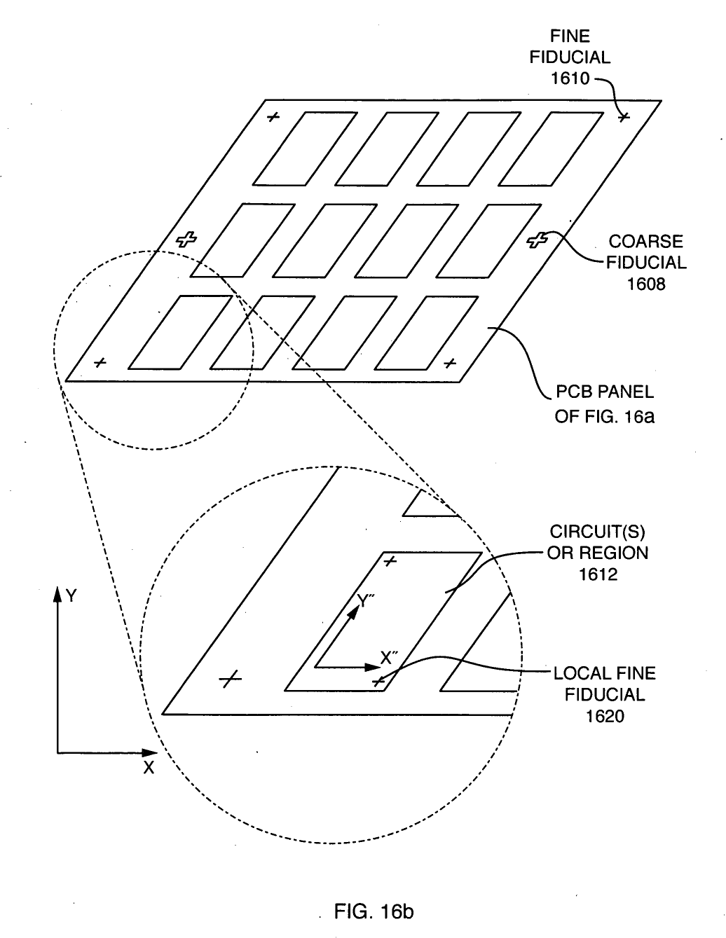

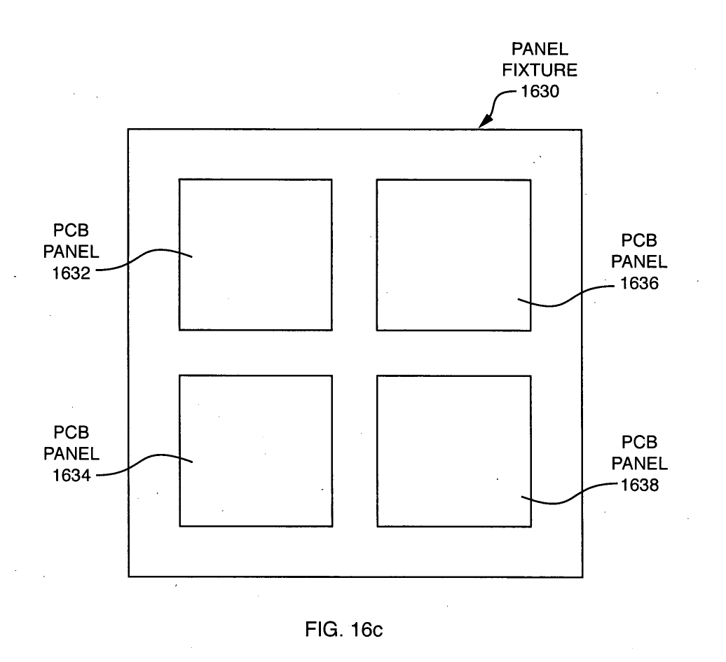

FIG. 16a depicts a PCB panel 1601 supported on a panel fixture 1605 in an unknown location and/or orientation. The PCB panel 1601 may have been placed on the panel fixture 1605 either manually or through some automatic loading means. The panel 1601 has coarse and fine fiducial marks, 1608 and 1610, as shown. Typically, there will be at least two coarse fiducials 1608, which are used for gross alignment of the panel 1601, and up to four fine fiducials 1610 (located near the panel corners) that are used for fine alignment of the panel 1601. The coarse fiducials 1608 could, for example, be similar to the image feature 1597 shown in FIG. 15c. The fine fiducials 1610 are normally smaller targets that could fit within a single field of view of a fine field camera field of view, such as field of view 1598 depicted in FIG. 15c.

Also shown in FIG. 16a is a circuit or region 1612 on the panel 1601 oriented in conjunction with the panel fiducials 1608 and 1610. For proper and accurate probing and laser trimming of the elements within the region 1612, accurate position information must be acquired by and available to the system prior to laser processing (e.g. trimming a resistor of a circuit or blasting/opening links in a memory array to isolate bad memory cells). As has been discussed above, the edges of PCB panel 1601 are often not well defined, making edge registration impractical. Furthermore, because the delicate underside of the panel 1601 is susceptible to damage, sliding of the panel 1601 on the panel fixture 1605 to correct for misorientation or offset is not permitted.

After loading the PCB panel 1601, the PCB panel 1601 is secured to the panel fixture 1605, for example, by vacuum pressure through vacuum holes disposed on the panel fixture 1605 as previously described. After the PCB panel 1601 is secured to the panel fixture 1605, the locations of both the coarse and fine fiducials are determined in order to map and transform the axes X′, Y′ of the panel 1601 to the system axes X, Y, shown in FIG. 16a.

To map the axes, the system typically will first acquire the positions of the coarse fiducials 1608. In this regard, X and Y stages will move the panel fixture 1605 to position the nominal locations of the coarse fiducials 1608 within a camera field of view, for example, the coarse camera field of view 1599, or the fine camera fields 1598 of view, as described above with reference to FIGS. 15a-15c. An image of each of the coarse fiducials 1608 is acquired and processed by the image processing electronics 556 and/or system controller 550 to determine the center of the imaged coarse fiducial 1608. The determined center of that imaged feature is, if appropriate, then fed back to the image processing electronics 556 or system controller 550.

The determined centers of the two coarse fiducials 1608 shown in this example embodiment are further processed by the processing electronics 556 or by the system controller 550 to determine the approximate transverse location and rotational offset of the panel 1601 with respect to the panel fixture 1605. Thereafter, the information obtained from the coarse fiducials 1608 (e.g., the determined feature center and offsets) is used by the controller 550 to direct acquisition of the four fine fiducial targets 1610, of which are shown disposed near the corners of the panel 1601. Using a similar technique, but now using only a fine field camera field of view as previously described, the fine fiducial images are acquired. The images are processed by the image processing electronics 556 and/or the system controller 550 to determine the center of each imaged fine fiducial. This information can be further processed, for example, by the image processing electronics 556 or the system controller 550 to precisely determine the transverse offset and the rotational offset of the panel 1601 with respect to the fixture 1605.

In summary, after the acquisition of the coarse fiducial 1608 and the fine fiducial 1610 target images, the system or vision subsystem image processing electronics execute conventional pattern recognition algorithms, either on a coarse field image or tiled fine field images in the case of the coarse fiducial, or a fine field image in the case of fine fiducials, to determine the coordinates of the center or another desired location relative to the center of each image feature. These coordinates are then further processed to determine the transverse and rotational offsets between the system coordinates and the panel coordinates using known algorithms, such as a reverse transformation. The system controller 550 or image processing electronics 556 then creates a map of the panel coordinate system X′, Y′ to the system coordinates X, Y. This provides the system controller 550 with the offset rotation, the offset transverse location in X, Y, the non-orthogonality and any other trapezoidal distortions of the panel 1601 with respect to the fixture 1605 in the system coordinates.

This alignment, transformation and mapping allows the system controller 550 to accurately determine the position of the panel 1601 on the panel fixture 1605 and, hence, to be able to accurately position and orient the probe card relative to any circuit on the panel, and to accurately position the laser beam and probe for accurate lasing and probing of any features disposed on the panel 1601. Note that this global alignment calibration may be performed on regions of the panel not necessarily encompassing all of the circuits on the panel. For example, it may be desirable, due to the presence of some non-linear distortions on the panel, to perform the above alignment calibration procedure multiple times to determine the appropriate location mappings for different areas covered by the respective alignments calibration.

Calibration to Circuit/Region

As shown in FIG. 16b, each of the circuits or regions 1612 on the PCB panel 1601 of FIG. 16a may include at least one local fine fiducial 1620. Images of the one or more proximate local fine fiducials 1620 are acquired and processed by the image processing electronics 556 and/or system controller 550 to precisely determine the transverse and rotational offsets of the coordinates of each circuit or region 1612 on the panel 1601, as indicated by X″, Y″ in FIG. 16b, in relation to the X, Y axes coordinates of the system. In the example shown in FIG. 16b, two local fine fiducials 1620 are acquired.

Transformation from X″, Y″ is accomplished by imaging the local fine fiducials 1620 in a manner similar to that previously described with respect to panel fine fiducials 1610 and coarse fiducials 1608 to calibrate alignment of the PCB panel 1601, as shown in FIG. 16a. The images of the local fine fiducials 1620 shown in FIG. 16b can be acquired, for example, using the fine field camera of either FIG. 15a or FIG. 15b. The center and transverse and rotational offsets of these local fine fiducials 1620 are determined from the acquired images as previously described using conventional or custom algorithms executed by the image processing electronics 556 of FIG. 9a.

During system operation, a first global or panel alignment calibration is performed using the coarse fiducials 1608 and fine fiducials 1610 of FIG. 16a. Prior to trimming, if high accuracy or large distortion in the panel 1601 is present, the local fine fiducials 1620 are next acquired for the circuit or region to be trimmed, and the transformation of the coordinates of the acquired local fine fiducials 1620 into the system coordinates is performed. The system then calibrates alignment of the probe card and trim locations to the applicable circuit or region 1612. During operation, and subsequent to the processing (e.g. trimming and probing) of the previously aligned circuit or region 1612, the system steps over to the next circuit or region 1612 and performs a similar alignment calibration using, if applicable, global and/or local fine fiducials in that next circuit/region. This procedure is repeated until all the circuits or regions 1612 on the PCB panel have been probed and trimmed, or otherwise processed.

In practice, the calculated transformation based on the alignment calibration data is used by the system controller 550 to transform the nominal trimming and probing locations (as stored in the database) into actual trimming and probing locations in system coordinates. Based on the alignment calibration data for the global panel and, if applicable, the local circuit/region, the system controller directs, for example, the X stage, the Y stage, and the Z and Theta stages to correctly orient and position the probe card relative to the trim circuit/region trim locations on the PCB panel. Specifically, the X stage is moved by the system controller 550 to move the panel fixture, and therefore the panel, along the X axis to compensate for an X offset determined in the alignment calibration processing. Similarly, the Y stage moves the panel fixture, and thus the panel, under control of the system controller 550 to compensate for any Y offset determined during the alignment calibration processing. The Theta stage is rotated and thereby rotates the probe card to compensate for any rotation determined during the alignment calibration processing. All of these actions serve to accurately position the probe card over the applicable circuit or region of the panel, and also accurately orient the laser beam locations over the elements to be trimmed or otherwise lased. The XY location of the panel and the theta rotation of the probe card aligned during the operations previously described may encompass the entire panel area, or regions of a panel including an individual circuit or group of circuits to be probed and/or trimmed.

It may be desirable for the system controller 550 to modify certain parameters used during the probing and lasing operations based on the alignment calibration data obtained. Parameters that may be affected include, but are not limited to, the trim start locations and directions of cut, the focus of the optical system with respect to the panel surface, and the probe card Z position with respect to the panel surface. Panel surface position data along the Z axis may be obtained during the global and/or local alignment calibration as has been described herein using the vision system 552 or other sensors.

Note that the above panel alignment operations may be completed on more than one distinct work piece or panel on the panel fixture. It is possible, in the case of panel sizes less than or equal to half of either or both of the panel fixture dimensions, e.g. the X and/or Y dimensions, to place two or more panels on the panel fixture for automatic processing. Additionally, two or more differing panels may also be placed and aligned on the panel fixture to minimize overheads by maximizing use of the panel fixture area. The global and/or local alignment calibration described herein may be implemented first on one panel, then on the next, and before and/or during trimming operations, until all of the panels concurrently supported on the panel fixture have been processed. FIG. 16c depicts an example panel fixture 1630 having multiple PCB panels disposed thereon. As shown, four PCB panels 1632, 1634, 1636 and 1638 are concurrently supported on the panel fixture 1630.

Note that various alternative configurations could be used implementing the principles described above to align the trimming laser subsystem, vision subsystem and/or probe to the panel. For example, the laser subsystem and probe could be moved by the X and Y stages, or the panel fixture could be moved by the Z-Theta stage. Alternatively, the panel fixture could be moved by one of the X or Y stages, while the laser subsystem and probe are moved by the other of the X, Y stages.

Processing Differently Oriented Circuits/Regions

In the circuit orientation shown in FIG. 16b, all of the circuits or regions to be probed are aligned similarly, in what is commonly referred to as being aligned in a simple step and repeat fashion. However, the orientation and locations of the circuits or regions could alternatively be as shown in FIG. 7b, which is typical of some PCB panel substrates.

In order to process the differently orientated circuits shown in FIG. 7b, 90 degree, 180 degree, or 270 degree rotation of the probe card relative to the PCB panel is required. In one embodiment, the Z-Theta stage, such as that shown in FIG. 9d, rotates through a rotation angle of at least 270 degrees, with some additional margin, in order to facilitate the necessary rotation of the probe card holder, and hence the probe card. More particularly, in addition to the small angular correction required for the alignment of the panel due to slight rotations of the panel and/or circuits/regions, as previously discussed, the Theta axis stage beneficially provides ninety-degree incremental rotations of the probe card holder to accommodate different rotational orientations of the circuits on the PCB panel, as shown in FIG. 7b.

The system controller 550, such as that shown in FIG. 9a, beneficially stores information in its database for the applicable panel and is programmed to process this information so as to control the Theta axis stage automatically during operations to perform the 90 degree, 180 degree or 270 degree rotations to properly position the probe card over the applicable circuit of a PCB panel of the type shown in FIG. 7b. Thus, the system controller 550, in addition to any small rotation corrections determined during the panel alignment calibration previously described, commands the theta stage to rotate the probe card by the required circuit layout orientation rotation. Note that the circuit orientations, although typically at 90 degree increments, are not limited in this respect. Rather, other angular orientation and increments could be used if so desired.

Automatic operation of the lasing system may involve automated loading and unloading of panels to and from the panel fixture using a panel handler (not shown). Special consideration must be given to the ranges and sequence of motion of the X, Y and Z stages of FIG. 9b during panel handler operation. Specifically, the travel of the X and Y stages is chosen such that there exists at least one location of the panel fixture at which a panel can be mounted onto or removed from the fixture thereon without obstruction by the Z-theta stage and probe card and holder assemblies. That is, vertical motion of the panel by the panel handler must be facilitated to allow the placement or removal of panels onto or from the panel fixture.

In this regard, the Z axis stage may be configured to provide for an additional vertical travel range such that sufficient handling clearance is achieved between the panel fixture surface and the Z-theta stage and probe card and holder assemblies, if the X and/or Y stages travel range is insufficient to clear all portions of the panel from obstruction. Thus, in such an embodiment, a stage motion sequence during panel handling would involve first moving the Z axis to its uppermost position, then moving the X and/or Y stages to position the panel mounting area of the panel fixture (and any mounted panel) to a designated loading/unloading position, prior to panel handler operation(s) to mount or remove a panel.

Sequenced Motion To Accommodate Automated Panel Handling

Automatic operation of the lasing system may also involve automated unloading of special panels using a panel handler (not shown) from the panel fixture to a special panel storage location within the lasing system. Special consideration must also be given to the ranges and sequence of motion of the XY stage of FIG. 9b during special panel handler operation. Specifically, for a special panel storage location positioned below but within the envelope of the panel fixture X, Y motion, the travel of the X and Y stages is chosen such that there exists at least one location of the panel fixture at which a special panel storage location is substantially clear from obstruction by the panel fixture. That is, vertical motion of the panel by the panel handler must be facilitated to allow the placement or removal of panels into or from the special panel storage location.

Thus, in such an embodiment, a stage motion sequence during special panel handling includes first moving the X and/or Y stages to position the panel fixture (and any mounted panel) in a designated loading/unloading position, lifting the panel from the panel fixture using a panel handler (not shown), moving the X and/or Y stages to position the panel fixture clear of the special panel storage location, and then placing the panel into the now unobstructed special panel storage location using the panel handler. A similar but reversed sequence can be implemented for the retrieval of a panel from the special panel storage location.

Step and Repeat X-Y Motion Path

The step and repeat time is defined as the time taken to move the PCB panel on the panel fixture using the X, Y, Z, and Theta stages from one circuit or region on the panel to the next. This time may be, for large PCB panels with many circuits, a significant fraction of the total processing time of a panel. There are two factors that contribute to the time taken to perform a step and repeat move. The first is the mass of the panel fixture and stages to be moved, and the second is the travel distance during the step and repeat motion.

As shown in FIG. 9b, the X stage 920 is mounted on top of the Y stage 925, and the panel fixture 930 is mounted to the X stage 920. Thus, in such an embodiment, only X stage 920 movements need be used, where possible such that the move time can be increased in speed with the lower mass being moved. It is also possible in another embodiment for the Y stage to be mounted on top of the X stage 920. Here, Y stage 925 movements would be used because of the higher speed and lower mass being moved. The mass, and hence, the speed of movement of the panel fixture 930 and thus the panel by a particular stage results in an initial preference selection.

The step distance must also be considered to determine the optimal preferential axis of motion. The larger the step distance required to align the circuit probe and lasing optics from alignment with one circuit or region on the panel to alignment with the next circuit or region, the longer the time required to perform the step and repeat motion. The time required to perform the step and repeat motion can be determined based on the known acceleration and velocity of, for example, the panel fixture on the stages for each of the X stage 925 and Y stage 920 in the system. Furthermore, the total time determined for the step and repeat operation can be computed from the distance required to move in each of the X and Y directions for all of the probing sites on the panel. In one embodiment, the system controller 550 is able to determine the step and repeat path, such that the total step and repeat time is minimized for the step and repeat operations required to complete the panel. In this way, the overall process time of the panel is optimized.

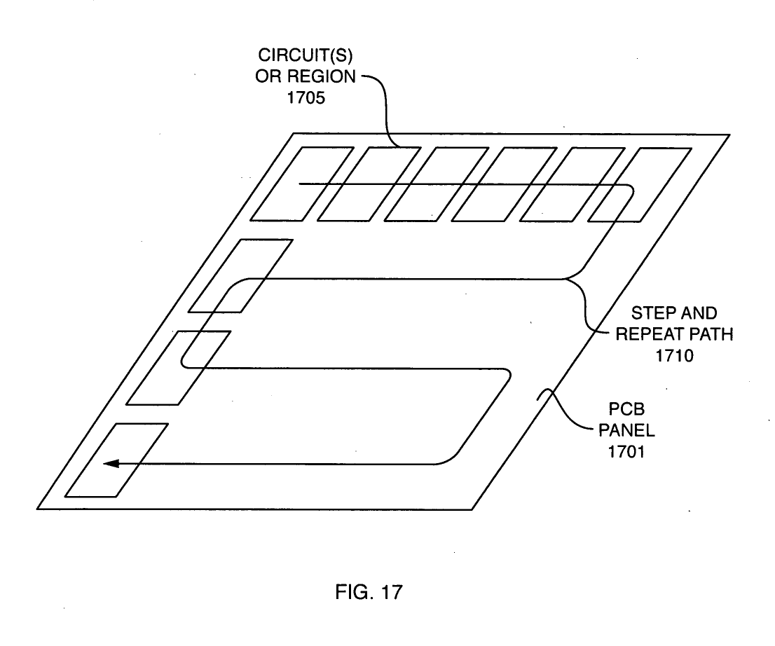

The PCB panel 1701 shown in FIG. 17 has multiple circuits or regions 1705 to be probed and trimmed, as indicated. During operation of the system, the X stage and Y stage are each commanded by the system controller 550 to position the circuits or regions underneath the probe card holder and laser subsystem optics for probing and trimming. In FIG. 17, the step and repeat path 1710 is selected based on the result of the previously described computations, and thus presents the optimal step and repeat path to minimize the total time to process the panel.

Depending upon the orientation of the circuits or regions on the panel, Z and Theta axis motion may also need to be considered in the step and repeat operation. The time taken for the motion of the Z and Theta axes can also be minimized by the selected optimum step and repeat path. More particularly, the Theta motion is often slower than the X and/or Y motion. Hence, the optimized path is beneficially selected to minimize the number of rotations of the Theta axis during processing of the panel side.

During the processing of the panel, the step and repeat action is typically characterized by a sequence of axis motions. Depending on the direction of the step and the orientation of the circuits to be lased and/or probed, some combination of the X, Y, Z, and Theta axes movements is involved. Note that as a result of global and/or local alignment calibration of the panel, as previously discussed, a step from one trim/probe site to another along one axis of the panel may also involve some small motion of the orthogonal axis stage. Since it is desirable to minimize the time required to execute the step within the velocity and acceleration limits of the stages involved, coordinating the motions of two or more axes stages during the move may be advantageous.

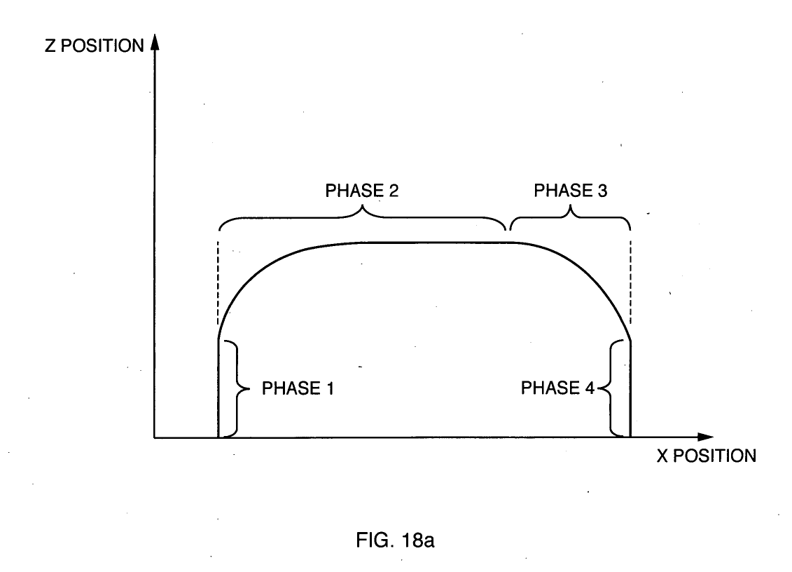

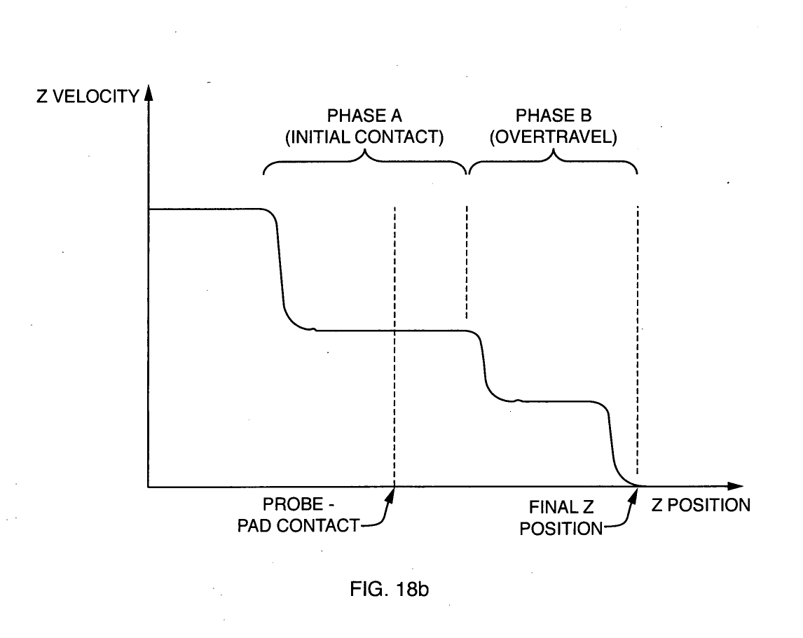

FIG. 18a depicts an example of a move profile during a step in which the direction of movement is predominantly along the X axis. As shown, the Z axis positioning is plotted with respect to the X axis motion. It can be seen that there exist several phases to the move. For the purposes of this description, the initial condition is assumed to be that of the probe positioned in contact with a first probe site (e.g., with a first circuit or region) on a panel.

The first phase movement is initiated by the system controller issuing command signals to position the probe with respect to the next XYZ coordinate (e.g., the next circuit or region) on the panel. Since the probe is in a contact state, the first phase begins by raising the Z axis stage without moving the X,Y stages so as to prevent probe and panel damage.

Once the Z axis has reached a Z position that clears the probe from contact with the panel, phase two begins. At this point the X stage is commanded to accelerate in the desired direction. At approximately this time, the Z stage continues moving at some velocity, and is commanded to decelerate into an upper probe position. Accordingly, the X stage motion commences before the Z stage has reached its upper position.

The third phase is initiated once the X stage is approaching its target position. At this point, the X stage is commanded to decelerate into its target position. Also at approximately this time, the Z stage is commanded to accelerate down into a lower probe position. Note that the Z stage may or may not be stationary prior to the second phase downward motion, depending on the relative times required for the Z stage deceleration into the upper position and the X stage acceleration and travel to its target position. That is, the Z stage may immediately reverse its direction of movement upon reaching the upper probe position. In one embodiment, the acceleration and velocity of the X and Z axes is chosen such that the X stage fully stops in its target position before the Z stage has moved from its upper position such that the probe contacts the circuit or region on the panel surface. Thus, Z stage motion may commence before, but ends after, the X axis stage has reached its target position. In the final phase, the Z axis stage decelerates into its final probe contact position, with X axis stage stationary in its target position.

As described, the acceleration and velocity capabilities of both the X and Z axis stages are used to minimize the step time. The parameters and timing for the coordinated motion may be determined empirically using known computational techniques and programmed into the stage controller (e.g., 544 of FIG. 9a) and/or the system controller (e.g., 550 of FIG. 9a). If desired, the described movements may be automatically directed by the stage or system controller based on position and/or velocity feedback from the stages. Note that a similar sequence may be coordinated for motion of the Y and/or Theta stages if required during the step and repeat operation.

FIG. 18b further details an embodiment of the final phase of FIG. 18a. In the final phase, the Z axis stage moves into the probe contact position. Actual contact preferably occurs only after the XY axes stages are stationary. Due to the interaction of the probe tips with the probe pad surface, it may desirable to limit the velocity or impact with which the probe tips come into contact with the pads during Z motion. Furthermore, the probe card containing the probe tips is typically driven or forced beyond the initial contact position by a small distance, termed overtravel, to ensure reliable contact. During the overtravel, some sliding of the probe tip on the pad may occur, especially for cantilever type probe tips, thus improving electrical contact with the pad.

As shown, the velocity of the Z axis is plotted with respect to Z position and the initial contact and final overtravel positions. The example Z velocity profile shown is characterized by two phases of deceleration. The first phase is a reduction in velocity to limit the probe tip impact with the pad surface. This reduction serves to prevent undue mechanical shock and possible damage to the probe tip and the probe pad, as well as limit possible probe tip bounce which could affect electrical contact. The second phase of the example final Z motion occurs after initial probe tip contact with the pad. Here, the Z stage velocity is further modified to best seat the probe tip into the probe pad surface. This final velocity and deceleration is chosen based on the overtravel desired, the probe type, the probe tip material, and the surface material and morphology of the probe pad.

FIG. 18b shows a further reduction in Z axis velocity during this final phase. However, based on the above factors, the final velocity may be chosen to be higher or lower than the initial contact velocity.

The system or stage controller (e.g., 550 or 564 of FIG. 9a) can be programmed or otherwise configured to control the stages to provide the preferred velocity profile based on absolute Z positions previously programmed, or alternatively by feedback from sensors able to determine the actual probe tip location with respect to the panel surface. In one embodiment, note that the sensors may be the probe tips themselves where the electrical characteristics of the probe tip are monitored during Z motion. Alternatively, the vision system 552 or some other distance measuring sensor located on the probe card, may be utilized.

Copper Tracing/Pad Adjustment Calibration

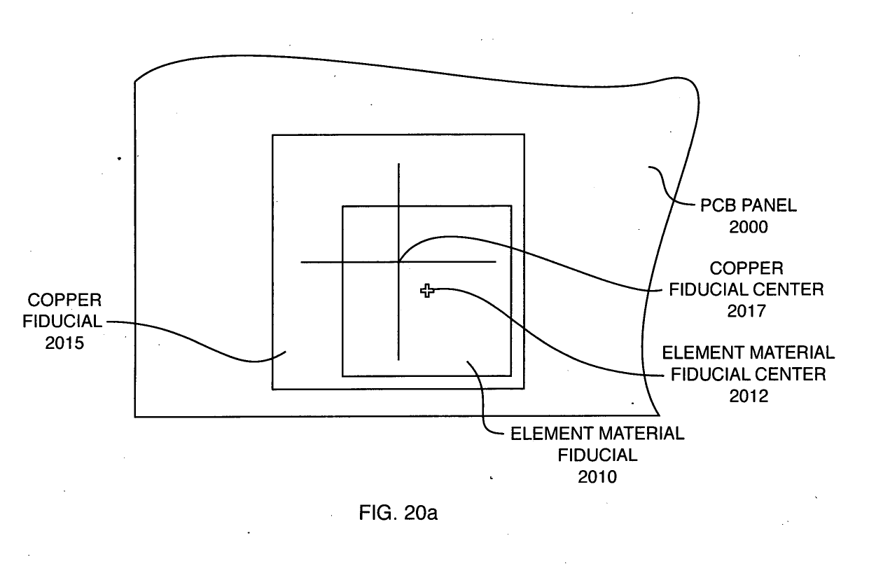

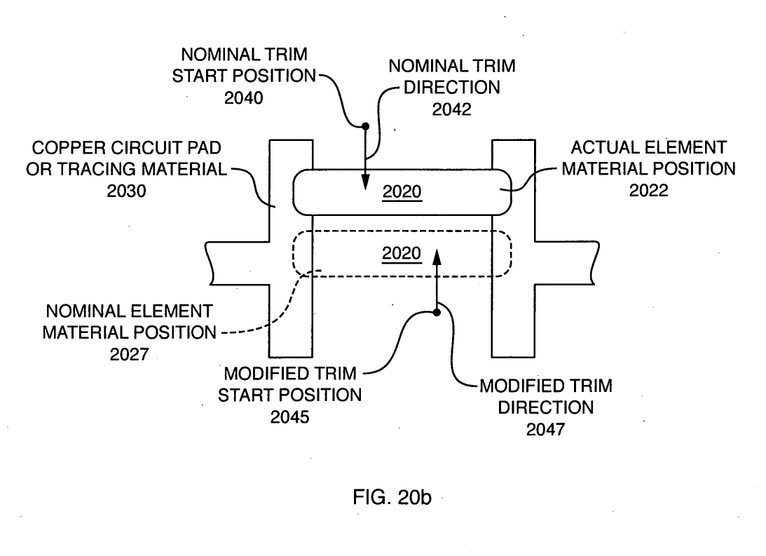

Traces on the PCB panel may be obtained during the global or the local alignment of the circuit panel or elements. FIG. 20a depicts an element material fiducial 2010 and a copper tracing pad fiducial 2015 on a panel 2000. The copper fiducial center 2017 and element material fiducial center 2012 are, as shown, offset slightly from one another. During global/local alignment, these fiducials may be acquired, in a manner similar to that previously described, using the vision subsystem 552. The offsets between the element material fiducial center 2012 and copper fiducial center 2017 may be determined, for example, at the four corners of the PCB panel 2000, or at local alignment sites for the circuit probing locations or other regions of the panel being processed.

FIG. 20b depicts an alternative technique for determining the offset of the actual position 2022 element material 2020 relative to copper circuit tracings or pads material 2030. As shown, the actual element material position 2022 differs from a nominal or expected element material position 2027 (e.g., the specified design position of the element material 2020) with respect to copper circuit material 2030. This offset can be determined by imaging the nominal element material position 2027 using the vision subsystem 552. The actual element material position 2022 is determined by the system controller 550 using the image data. This position can then be compared by the system controller 550 to the nominal element material position 2027, which is typically stored at the system controller 550 to determine the offset.

The system controller 550 is typically programmed to start a trim operation at nominal trim start position 2040, as shown in FIG. 20b and to proceed with trimming in the nominal trim direction 2042. Based on the determined offset between the actual element material position 2022 and the nominal element material position 2027, the system controller 550 determines a modified trim start position 2045 and trim direction 2047, in order to achieve improved trimming of the element material 2020.

The reason for selecting the modified trim start position 2045 and trim direction 2047 could, for example, be to prevent damage to adjacent material that would occur if the nominal trim start position 2040 and trim direction 2042 were utilized. For example, due to the offset between the nominal and actual positions, adjacent material could be located at the nominal start position 2040 depicted in FIG. 20b, and hence this material could be damaged or destroyed if trimming were begun at the nominal start position 2040, rather than the modified start position 2045. Therefore, the system controller 550 modifies the trim direction and trim start position as indicated in FIG. 20b, either from image data obtained from the fiducials of FIG. 20a or from local fiducials, or from the element material itself as described with reference to FIG. 20b.

It is common for PCB panels to contain element materials deposited at different steps of the production process, which may be located with some offset from one another. In a manner similar to that described herein, the location of one element material relative to another element material may be determined, and suitable adjustment to trim start locations and directions could be made for each element material and its location. Furthermore, the sizes of deposited element material features, whether fiducials or actual circuit elements, may be determined during this alignment calibration and used by the system controller 550 to adjust the trim start locations and directions, etc.

The system controller 550 of FIG. 9a could make modifications to the trim directions and trim start positions as indicated in FIG. 20b, either based on global data obtained from fiducials of FIG. 20a, or local data obtained from local fiducials or local element material of FIG. 20b during system operation. The data obtained in the alignment calibration may be further used by the system controller 550 to adjust other global, material, or element specific trim types and parameters used during operation. Also, the viability of the trim itself in terms of meeting target tolerance and quality may be computed by the system controller 550 prior to trimming. This information can be used as a decision point for the system controller 550 when trimming a panel and help to speed the trimming process by not performing probing and/or trimming processes on the affected elements, materials, circuits, regions, or panels which lie outside minimum criteria for trimability.

The material offset data obtained during the alignment may be recorded and used by the automated trimming system to optimize probing and/or trimming parameters, or used by subsequent production processes in the manufacturing of the PCB panels. It is typical for errors to be present in the as-patterned element and circuit copper material location in the form of offsets, scale errors, and geometry errors. Calculations based on the alignment calibration data may be performed by the system controller 550 to provide recordable or transmittable values for these errors which can be used for future analysis and/or to correct the processes involved during PCB production prior to the probing and trimming operations on the automated trimming system.

While various embodiments of the invention are described herein, the present invention is not intended to be limited to any particular one or group. Various features and aspects of the above described invention may be used individually or jointly. Further, although various embodiments of the invention are described herein in the context of a particular environments and applications (e.g. trimming or drilling circuit boards), the principles of the present invention can be beneficially utilized in any number of environments and applications, such as the machining of silicon waters or blasting of links in redundant memory.

1. A system for probing circuit elements, comprising:
a fixture having a platen surface configured to support a work piece having a target element;
a probe holder configured to support a probe for detecting a characteristic of the target element;
a first stage configured to rotate the probe holder about an axis substantially orthogonal to the platen surface, thereby enabling differently orientated circuits on the work piece to be probed;
a second stage operatively coupled to the first stage and configured to move the probe holder substantially parallel to the axis; and
a controller configured to control the first stage, so as to automatically align probe tips of the probe with corresponding probe locations associated with the target element.

2. The system of claim 1 further comprising:
an emitter configured to emit a beam of light to lase the target element, wherein the probe is further configured to detect the characteristic of the target element at least one of before, during, and after lasing.

3. The system of claim 1 wherein the second stage is further configured to move the probe holder between a first stop location where the probe tips do not contact their corresponding probe locations and a second stop location where the probe tips contact their corresponding probe locations.

4. The system of claim 3 wherein the second stage is further configured to move the probe holder to a third stop location located between the first and the second stop locations and at which the supported probe will not contact the probe locations.

5. The system of claim 1 wherein the second stage is further configured to move the probe holder to a first stop location for loading of the work piece onto the fixture, and to a second stop location with the work piece loaded on the fixture.

6. The system of claim 1 further comprising:
a third stage configured to move the fixture substantially parallel to the platen surface;
wherein the second stage is further configured to move the probe holder to a first stop location during loading of the work piece onto the fixture, to a third stop location during third stage movement of the fixture with the work piece loaded on the fixture, and to a second stop location during probing of the target element.

7. The system of claim 1 further comprising:
a second stage configured to move the probe holder substantially parallel to the axis; and
a third stage configured to move the fixture substantially parallel to the platen surface.

8. The system of claim 7 wherein the third stage is configured to move the fixture in a first direction, the system further comprising:
a fourth stage configured to move the fixture in a second direction substantially parallel to the platen surface and perpendicular to the first direction.

9. The system of claim 7 wherein the second stage is mounted to the first stage, and either the third stage is further configured to move the fourth stage with the fixture in the first direction or the fourth stage is further configured to move the third stage with the fixture in the second direction.

10. The system of claim 7 wherein the third and fourth stages are further configured to move at a different accelerations.

11. The system of claim 7 wherein the third stage is further configured to move over a first travel distance, and the fourth stage is further configured to move over a second travel distance.

12. The system of claim 11 wherein the first stage is further configured to move at a first acceleration, and the second stage is further configured to move at a second acceleration.

13. The system of claim 12 wherein the first travel distance is greater than the second travel distance, and the first acceleration is greater than the second acceleration.

14. The system of claim 12 wherein the first stage is configured to rotate the probe holder through an angle in the range of at least 40 degrees to 280 degrees.

15. A system for probing circuit elements, comprising:
a fixture having a surface configured to support a work piece having a target element;
a probe holder configured to support a probe for detecting a characteristic of the target element;
a first stage configured to rotate the probe holder about an axis substantially orthogonal to the surface;
a controller configured to control the first stage, so as to automatically align probe tips of the probe with corresponding probe locations associated with the target element;
an emitter configured to emit a beam of light to lase the target element; and
a camera positioned to view the target element through the scan lens, wherein the camera has a viewing path that is substantially coaxial with a path of the beam.

16. The system of claim 15 further comprising:
a focus telescope configured to simultaneously maintain optical focus of both the beam and the camera at the target element.

17. A system for probing circuit elements, comprising:
a fixture having a platen surface configured to support a work piece having a target element, the fixture including a calibration subassembly configured to aid automatic calibration during at least one of probe card planarization, probe card alignment, galvo calibration, laser power measurement, and probe tip cleaning;
a probe holder configured to support a probe for detecting a characteristic of the target element; and
a first stage configured to rotate the probe holder about an axis substantially orthogonal to the platen surface, so as to automatically align probe tips of the probe with corresponding probe locations associated with the target element.

18. The system of claim 17 wherein the calibration subassembly includes a planarization plate for use during automatic planarization of the probe relative to the work piece.

19. The system of claim 17 wherein the calibration subassembly includes a probe alignment plate having conductive test features for use during automatic probe alignment, where X-Y offset and theta rotation offset between the work piece and the probe are determined.

20. The system of claim 17 wherein the calibration subassembly includes a calibration aperture and a detector used for at least one of automatically determining position of the beam within a scan field and correlating beam path to a vision path.

21. The system of claim 17 wherein the calibration subassembly includes a power meter head for use in automatically measuring power of the beam at the work piece.

22. The system of claim 17 wherein the calibration subassembly includes a probe tip scrub pad for use in automatically cleaning the probe tips of the probe.

23. The system of claim 17 wherein the calibration subassembly is accessible even when work piece is mounted on the fixture, thereby allowing real-time automatic calibration procedures to be carried out.

24. The system of claim 17 wherein the calibration subassembly is in substantially the same plane as the platen surface.

25. A system for positioning a work piece for lasing, comprising:
a fixture having a surface substantially parallel to a plane and defined by a first axis and a second axis that is orthogonal to the first axis, the surface for supporting a work piece configured with a plurality of different areas disposed thereon, with each area including one or more circuit elements to be lased;
a first stage configured to move the fixture substantially parallel to the plane and the first axis;
a second stage configured to move the first stage and the fixture substantially parallel to the plane and the second axis; and
a controller configured to determine a path for movement between the different areas by directing movement of the first stage and the second stage based on distances along the first axis between each of the different areas and distances along the second axis between each of the different areas, thereby positioning each of the plurality of different areas for lasing the one or more circuit elements included in that area.

26. The system of claim 25 wherein the controller is further configured to compute total time periods of movement of the first and the second stages to move the work piece respectively along the path based on the distances along the first axis and the distances along the second axis, to compare the computed total time periods, and to direct the movement of the first and the second stages in accordance with a result of the comparison.

27. The system of claim 25 wherein the controller is further configured to determine a path for movement that is associated with a travel time that is comparable or shorter than travel time of other possible paths.

28. The system of claim 27 further comprising:
a probe for measuring a characteristic of the one or more circuit elements included in the each area after positioning that area in a lasing position;
wherein the controller is further configured to compute rotation of the probe in correspondence with the movement of the work piece along the path, based on the respective angular orientation of each of the plurality of different areas.
